(19) United States
(12) Patent Application Publication
(10) Pub. No.: US 2024/0373051 A1
(43) Pub. Date: Nov. 7, 2024

(54) VIDEO ENCODING AND DECODING METHOD USING CODE BIT HIDING

(71) Applicant: INDUSTRY ACADEMY COOPERATION FOUNDATION OF SEJONG UNIVERSITY, Seoul (KR)

(72) Inventors: Yung Lyul LEE, Seoul (KR); Myung Jun KIM, Guri-si, Gyeonggi-do (KR); Hyeon Ju SONG, Seoul (KR); Su Yeon LIM, Namyangju-si, Gyeonggi-do (KR)

(21) Appl. No.: 18/575,772

(22) PCT Filed: Jun. 23, 2022
(86) PCT No.: PCT/KR2022/008976

§ 371 Date: Jan. 5, 2024

(30) Foreign Application Priority Data
Jul. 1, 2021 (KR) 10-2021-0086307
Mar. 18, 2022 (KR) 10-2022-0033956

(51) Int. Cl. H04N 19/46; H04N 19/176; H04N 19/18

(52) U.S. Cl. CPC H04N 19/46; H04N 19/176; H04N 19/18

(57) ABSTRACT

In the present disclosure, a video decoding method is provided, including obtaining differential motion vector size information indicating a size of a differential motion vector of a current block, obtaining a sign bit hiding flag indicating whether or not sign bit hiding of the differential motion vector of the current block is performed, determining a sign of the differential motion vector without obtaining differential motion vector sign information on the sign of the differential motion vector, when the sign bit hiding flag indicates that the sign bit hiding of the differential motion vector is performed, and determining the differential motion vector according to the size of the differential motion vector based on the differential motion vector size information and the determined sign of the differential motion vector.

### TECHNICAL FIELD

The present invention relates to a video encoding and decoding method, and more particularly, to a video encoding and decoding method using sign bit hiding.

### BACKGROUND ART

In recent years, demand for multimedia data such as video has been rapidly increasing on the Internet. However, the pace of advancement in the bandwidth of a channel can hardly follow the amount of multimedia data on a rapid increase. To solve this problem, among international standardization organizations, ITU-T's VCEG (Video Coding Expert Group) and ISO/IEC's MPEG (Moving Picture Expert Group) are working on further improved video compression standards through joint research.

Video encoding consists mainly of intra prediction, inter prediction, transform, quantization, entropy coding, and in-loop filter. Transform and quantization may be performed on a residual block of each block that is determined by block partitioning of an image. In addition, transform coefficient information may be generated for a transform coefficient block that is determined according to transform and quantization.

Video encoding efficiency may be improved by reducing a size of transform coefficient information through a distribution of transform coefficient values, redundancy between transform coefficients, and the like. Also, in inter prediction, video encoding efficiency may be improved by reducing a size of information on a differential motion vector.

### DISCLOSURE

### Technical Problem

As the resolution of an image increases, the size of an encoded image data is dramatically increasing. Accordingly, video encoding efficiency may be improved by reducing sign information on signs of a transform coefficient and a differential motion vector.

### Technical Solution

In the present disclosure, a video decoding method is provided including obtaining transform coefficient size information on a size of predetermined transform coefficients among transform coefficients of a current block, obtaining a sign bit hiding flag indicating whether or not sign bit hiding of the predetermined transform coefficients of the current block is performed, determining a sign of the predetermined transform coefficients without obtaining transform coefficient sign information on the sign of the predetermined transform coefficients, when the sign bit hiding flag indicates that the sign bit hiding of the predetermined transform coefficients is performed, and determining the predetermined transform coefficients according to the size of the predetermined transform coefficients based on the transform coefficient size information and the determined sign of the predetermined transform coefficients.

In an embodiment, the determining of the sign of the predetermined transform coefficients may include determining a sign bit cost for each of sign combinations for the predetermined transform coefficients, determining an optimal sign combination according to the sign bit cost, and determining the sign of the predetermined transform coefficients according to the optimal sign combination.

In an embodiment, the determining of the sign bit cost for each of the sign combinations may include determining a residual block of the current block according to a sign combination, determining a reconstructed block of the current block from the residual block, and determining a sign bit cost of the sign combination based on the reconstructed block and a neighboring block of the current block.

In an embodiment, the determining of the residual block of the current block according to the sign combination may determine, according to fast inverse transform, the residual block of the current block according to the sign combination.

In an embodiment, the determining of the sign bit cost of the sign combination based on the reconstructed block and the neighboring block of the current block may determine the sign bit cost of the sign combination according to similarity between samples of the reconstructed block adjacent to a left boundary of the current block and samples of a left neighboring block of the current block and similarity between samples of the reconstructed block adjacent to an upper boundary of the current block and samples of an upper neighboring block of the current block.

In an embodiment, the determining of the sign bit cost of the sign combination based on the reconstructed block and the neighboring block of the current block may determine the sign bit cost of the sign combination according to at least one of a size of the current block, a prediction mode, a transform mode, and a quantization parameter.

In an embodiment, the determining of the optimal sign combination according to the sign bit cost may determine a sign combination with a least sign bit cost as the optimal sign combination.

In an embodiment, the obtaining of the sign bit hiding flag may include obtaining a sign bit hiding enable flag indicating whether or not sign bit biding is allowed for one of a coding tree block of the current block, a slice, a tile, a picture, a sequence, and a video and obtaining the sign bit hiding flag when the sign bit hiding enable flag indicates that the sign bit hiding is allowed.

In an embodiment, the predetermined transform coefficients may be determined by at least one of a scan order of the current block, a threshold value of the transform coefficient size, and a position of the transform coefficients.

In an embodiment, the number of the predetermined transform coefficients is equal to or greater than 3.

In the present disclosure, a video encoding method is provided including determining transform coefficients of a current block, encoding transform coefficient size information on a size of predetermined transform coefficients among the transform coefficients of the current block, determining whether or not sign bit hiding for a sign of the predetermined transform coefficients is performed, and encoding a sign bit hiding flag indicating whether or not sign bit information of the predetermined transform coefficients is omitted.

In an embodiment, the determining of whether or not sign bit hiding for a sign of the predetermined transform coefficients is performed may include determining a sign bit cost for each of sign combinations applicable to the predetermined transform coefficients, determining an optimal sign combination among the sign combinations applicable to the predetermined transform coefficients according to the sign bit cost, and determining, according to the optimal sign combination, whether or not sign bit hiding of the predetermined transform coefficients is performed.

In an embodiment, the determining of the sign bit cost for each of the sign combinations may include determining a residual block of the current block according to a sign combination, determining a reconstructed block of the current block from the residual block, and determining a sign bit cost of the sign combination based on the reconstructed block and a neighboring block of the current block.

In an embodiment, the determining of the residual block of the current block according to the sign combination may determine, according to fast inverse transform, the residual block of the current block according to the sign combination.

In an embodiment, the determining of the sign bit cost of the sign combination based on the reconstructed block and the neighboring block of the current block may determine the sign bit cost of the sign combination according to similarity between samples of the reconstructed block adjacent to a left boundary of the current block and samples of a left neighboring block of the current block and similarity between samples of the reconstructed block adjacent to an upper boundary of the current block and samples of an upper neighboring block of the current block.

In an embodiment, the determining of the sign bit cost of the sign combination based on the reconstructed block and the neighboring block of the current block may determine the sign bit cost of the sign combination according to at least one of a size of the current block, a prediction mode, a transform mode, and a quantization parameter.

In an embodiment, the determining of whether or not sign bit hiding of the predetermined transform coefficients is performed, according to the optimal sign combination, may determine whether or not sign bit hiding of the predetermined transform coefficients is performed, according to whether or not the optimal sign combination among the sign combinations applicable to the predetermined transform coefficients corresponds to a sign combination applied to the predetermined transform coefficients.

In an embodiment, the video encoding method may further include encoding a sign bit hiding enable flag indicating whether or not sign bit hiding is allowed for one of a coding tree block of the current block, a slice, a tile, a picture, a sequence, and a video, and the determining of whether or not sign bit hiding of the predetermined transform coefficients is performed and the encoding of the sign bit hiding flag indicating whether or not sign bit information of the predetermined transform coefficients is omitted may be performed when the sign bit hiding enable flag indicates that sign bit hiding is allowed.

In an embodiment, the predetermined transform coefficients may be determined by at least one of a scan order of the current block, a threshold value of the transform coefficient size, and a position of the transform coefficients.

In an embodiment, the number of the predetermined transform coefficients is equal to or greater than 3.

In the present disclosure, a computer-readable recording medium storing a bitstream generated by the video encoding method is provided.

In the present disclosure, a video decoding method is provided including: obtaining differential motion vector size information indicating a size of a differential motion vector of a current block; obtaining a sign bit hiding flag indicating whether or not sign bit hiding of the differential motion vector of the current block is performed; determining a sign of the differential motion vector without obtaining differential motion vector sign information on the sign of the differential motion vector, when the sign bit hiding flag indicates that the sign bit hiding of the differential motion vector is performed; and determining the differential motion vector according to the size of the differential motion vector based on the differential motion vector size information and the determined sign of the differential motion vector.

In an embodiment, the determining of the sign of the differential motion vector may include: determining a sign bit cost for each of sign combinations for the differential motion vector; determining an optimal sign combination according to the sign bit cost; and determining the sign of the differential motion vector according to the optimal sign combination, and a sign combination with a least sign bit cost is determined as an optimal sign combination.

According to an embodiment, the determining of the sign bit cost for each of the sign combinations for the differential motion vector may include: determining a reference block of the current block according to a sign combination; and determining a sign bit cost of the sign combination from a plurality of neighboring pixels of the current block and a plurality of neighboring pixels of the reference block, and a position of the plurality of neighboring pixels of the current block and a position of the plurality of neighboring pixels of the reference block may correspond to each other.

According to an embodiment, the determining of the sign bit cost of the sign combination from the neighboring pixels of the current block and the neighboring pixels of the reference block may include: determining an absolute value of a differential value between the neighboring pixels of the current block and the neighboring pixels of the reference block; and determining the sign bit cost of the sign combination from the absolute value of the differential value.

According to an embodiment, the determining of the sign bit cost of the sign combination from the plurality of neighboring pixels of the current block and the plurality of neighboring pixels of the reference block may include determining a range of the plurality of neighboring pixels of the current block, and a range of the plurality of neighboring pixels of the reference block may correspond to the range of the plurality of neighboring pixels of the current block.

According to an embodiment, the range of the plurality of neighboring pixels of the current block may include neighboring pixels in a predetermined position around the current block, and the plurality of neighboring pixels of the current block may be a predetermined number of neighboring pixels.

According to an embodiment, when the current block is bi-predicted, a first sign bit hiding flag indicating whether or not sign bit hiding of a first differential motion vector of the current block is performed and a second sign bit hiding flag indicating whether or not a second differential motion vector of the current block is performed may be obtained, when the first sign bit hiding flag indicates that the sign bit hiding of the first differential motion vector is performed, a sign of the first differential motion vector may be determined without obtaining first differential motion vector sign information on the sign of the first differential motion vector, the first differential motion vector may be determined according to a size of the first differential motion vector based on first differential motion vector size information and the determined sign of the first differential motion vector, when the second sign bit hiding flag indicates that the sign bit hiding of the second differential motion vector is performed, a sign of the second differential motion vector may be determined without obtaining second differential motion vector sign information on the sign of the second differential motion vector, and the second differential motion vector may be determined according to a size of the second differential motion vector based on second differential motion vector size information and the determined sign of the second differential motion vector.

According to an embodiment, when the current block is bi-predicted, a single sign bit hiding flag indicating whether or not sign bit hiding of a first differential motion vector and a second differential motion vector of the current block is performed may be obtained, when the sign bit hiding flag indicates that the sign bit hiding of the first differential motion vector and the second differential motion vector is performed, a sign of the first differential motion vector and a sign of the second differential motion vector may be determined without obtaining first differential motion vector sign information on the sign of the first differential motion vector and second differential motion vector sign information on the sign of the second differential motion vector, the first differential motion vector may be determined according to a size of the first differential motion vector based on first differential motion vector size information and the determined sign of the first differential motion vector, and the second differential motion vector may be determined according to a size of the second differential motion vector based on second differential motion vector size information and the determined sign of the second differential motion vector.

According to an embodiment, when the current block is bi-predicted, a single sign bit hiding flag indicating whether or not sign bit hiding of a first differential motion vector is performed may be obtained, when the sign bit hiding flag indicates that the sign bit hiding of the first differential motion vector is performed, a sign of the first differential motion vector may be determined without obtaining first differential motion vector sign information on the sign of the first differential motion vector, the first differential motion vector may be determined according to a size of the first differential motion vector based on first differential motion vector size information and the determined sign of the first differential motion vector, and the second differential motion vector may be determined based on the determined first differential motion vector.

According to an embodiment, the obtaining of the sign bit hiding flag may include: obtaining a sign bit hiding enable flag indicating whether or not sign bit biding is allowed for one of a coding tree block of the current block, a slice, a tile, a picture, a sequence, and a video; and obtaining the sign bit hiding flag when the sign bit hiding enable flag indicates that the sign bit hiding is allowed.

In the present disclosure, a video encoding method is provided including: determining a differential motion vector of a current block; encoding differential motion vector size information on a size of the differential motion vector of the current block; determining whether or not sign bit hiding for a sign of the differential motion vector is performed; and encoding a sign bit hiding flag indicating whether or not sign bit information of the differential motion vector is omitted.

According to an embodiment, the determining of whether or not the sign bit hiding for the sign of the differential motion vector is performed may include: determining a sign bit cost for each of sign combinations applicable to the differential motion vector; determining an optimal sign combination among the sign combinations applicable to the differential motion vector according to the sign bit cost; and determining, according to the optimal sign combination, whether or not the sign bit hiding of the differential motion vector is performed.

According to an embodiment, the determining of the sign bit cost for each of the sign combinations for the differential motion vector may include: determining a reference block of the current block according to a sign combination; and determining a sign bit cost of the sign combination from a plurality of neighboring pixels of the current block and a plurality of neighboring pixels of the reference block, and a position of the plurality of neighboring pixels of the current block and a position of the plurality of neighboring pixels of the reference block may correspond to each other.

According to an embodiment, the determining of the sign bit cost of the sign combination from the neighboring pixels of the current block and the neighboring pixels of the reference block may include: determining an absolute value of a differential value between the neighboring pixels of the current block and the neighboring pixels of the reference block; and determining the sign bit cost of the sign combination from the absolute value of the differential value.

According to an embodiment, the determining of the sign bit cost of the sign combination from the plurality of neighboring pixels of the current block and the plurality of neighboring pixels of the reference block may include determining a range of the plurality of neighboring pixels of the current block, and a range of the plurality of neighboring pixels of the reference block may correspond to the range of the plurality of neighboring pixels of the current block.

According to an embodiment, the range of the plurality of neighboring pixels of the current block may include neighboring pixels in a predetermined position around the current block, and the plurality of neighboring pixels of the current block may be a predetermined number of neighboring pixels.

According to an embodiment, when the current block is bi-predicted, a first differential motion vector and a second differential motion vector of the current block may be determined, first differential motion vector size information on a size of the first differential motion vector and second differential motion vector size information on a size of the second differential motion vector may be encoded, and a first sign bit hiding flag indicating whether or not sign bit hiding for a sign of the first differential motion vector is performed and a second sign bit hiding flag indicating whether or not sign bit hiding for a sign of the second differential motion vector is performed may be encoded.

According to an embodiment, when the current block is bi-predicted, a first differential motion vector and a second differential motion vector of the current block may be determined, first differential motion vector size information on a size of the first differential motion vector and second differential motion vector size information on a size of the second differential motion vector may be encoded, and a single sign bit hiding flag indicating whether or not sign bit hiding for a sign of the first differential motion vector and a sign for the second differential motion vector is performed may be encoded.

According to an embodiment, when the current block is bi-predicted and a second differential motion vector of the current block is determined from a first differential motion vector of the current block, first differential motion vector size information on a size of the first differential motion vector and second differential motion vector size information on a size of the second differential motion vector may be encoded, and a single sign bit hiding flag indicating whether or not sign bit hiding for a sign of the first differential motion vector is performed may be encoded.

According to an embodiment, the encoding of the sign bit hiding flag may include: encoding a sign bit hiding enable flag indicating whether or not sign bit biding is allowed for one of a coding tree block of the current block, a slice, a tile, a picture, a sequence, and a video; and encoding the sign bit hiding flag when the sign bit hiding enable flag indicates that the sign bit hiding is allowed.

In the present disclosure, a computer-readable recording medium storing a bitstream generated by the video encoding method is provided.

### Advantageous Effects

Sign information of a transform coefficient may be omitted by a sign bit hiding process of a transform coefficient and a differential motion vector according to the present invention. Accordingly, an amount of information generated by transform coefficient encoding may be reduced. Thus, video encoding efficiency is improved so that high-definition video may become easier to generate and disseminate.

### DESCRIPTION OF DRAWINGS

FIG. 1 is a block diagram showing an image encoding apparatus according to an embodiment of the present invention.

FIG. 2 is a block diagram showing an image decoding apparatus according to an embodiment of the present invention.

FIG. 3 shows an image encoding method that encodes a transform coefficient block through sign bit hiding.

FIG. 4 shows one example of a transform coefficient block and a sign combination of transform coefficients of the transform coefficient block.

FIG. 5 describes fast inverse transform according to a floating-point type DCT2 method.

FIG. 6 describes a method of determining a residual block according to fast inverse transform according to a floating-point type DCT2 method.

FIG. 7 describes one example of a transform coefficient block and fast inverse transform according to an integer-type DCT2 method.

FIGS. 8 to 10 describe a method for determining residual blocks of each of a plurality of blocks constituting a transform coefficient block.

FIG. 11 shows one embodiment for determining a sign bit cost.

FIG. 12 describes a video decoding method using sign bit hiding.

FIG. 13 describes a video encoding method using sign bit hiding.

FIG. 14 shows an image encoding method that encodes a differential motion vector through sign bit hiding.

FIG. 15 and FIG. 16 describe a sign combination of a differential motion vector.

FIG. 17 shows an image decoding method that decodes a differential motion vector through sign bit hiding.

FIG. 18 and FIG. 19 illustrate one embodiment for a method of determining a sign bit cost for sign bit hiding of a differential motion vector.

### MODE FOR INVENTION

A variety of modifications may be made to the present invention and there are various embodiments of the present invention, examples of which will now be provided with reference to drawings and described in detail. However, the present invention is not limited thereto, although the exemplary embodiments can be construed as including all modifications, equivalents, or substitutes in a technical concept and a technical scope of the present invention. In the drawings, the similar reference numerals refer to the same or similar functions in various aspects. In the drawings, the shapes and dimensions of elements may be exaggerated for clarity. In the following detailed description of the present invention, references are made to the accompanying drawings that show, by way of illustration, specific embodiments in which the invention may be practiced. These embodiments are described in sufficient detail to enable those skilled in the art to implement the present invention. It should be understood that various embodiments of the present invention, although different, are not necessarily mutually exclusive. For example, specific features, structures, and characteristics described herein, in connection with one embodiment, may be implemented within other embodiments without departing from the spirit and scope of the present invention. In addition, it should be understood that the location or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to what the claims claim.

Terms used in the specification, ‘first’, ‘second’, etc. can be used to describe various components, but the components are not to be construed as being limited to the terms. The terms are only used to differentiate one component from other components. For example, the ‘first’ component may be named the ‘second’ component without departing from the scope of the present invention, and the ‘second’ component may also be similarly named the ‘first’ component. The term ‘and/or’ includes a combination of a plurality of items or any one of a plurality of terms.

It will be understood that when an element is simply referred to as being ‘connected to’ or ‘coupled to’ another element without being ‘directly connected to’ or ‘directly coupled to’ another element in the present description, it may be ‘directly connected to’ or ‘directly coupled to’ another element or be connected to or coupled to another element, having the other element intervening therebetween. In contrast, it should be understood that when an element is referred to as being “directly coupled” or “directly connected” to another element, there are no intervening elements present.

Furthermore, constitutional parts shown in the embodiments of the present invention are independently shown so as to represent characteristic functions different from each other. Thus, it does not mean that each constitutional part is constituted in a constitutional unit of separated hardware or software. In other words, each constitutional part includes each of enumerated constitutional parts for convenience. Thus, at least two constitutional parts of each constitutional part may be combined to form one constitutional part or one constitutional part may be divided into a plurality of constitutional parts to perform each function. The embodiment where each constitutional part is combined and the embodiment where one constitutional part is divided are also included in the scope of the present invention, if not departing from the essence of the present invention.

The terms used in the present specification are merely used to describe particular embodiments, and are not intended to limit the present invention. An expression used in the singular encompasses the expression of the plural, unless it has a clearly different meaning in the context. In the present specification, it is to be understood that terms such as “including”, “having”, etc. are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added. In other words, when a specific element is referred to as being “included”, elements other than the corresponding element are not excluded, but additional elements may be included in embodiments of the present invention or the scope of the present invention.

In addition, some of constituents may not be indispensable constituents performing essential functions of the present invention but be selective constituents improving only performance thereof. The present invention may be implemented by including only the indispensable constitutional parts for implementing the essence of the present invention except the constituents used in improving performance. The structure including only the indispensable constituents except the selective constituents used in improving only performance is also included in the scope of the present invention.

Hereinafter, embodiments of the present invention will be described in detail with reference to the accompanying drawings. In describing exemplary embodiments of the present invention, well-known functions or constructions will not be described in detail since they may unnecessarily obscure the understanding of the present invention. The same constituent elements in the drawings are denoted by the same reference numerals, and a repeated description of the same elements will be omitted.

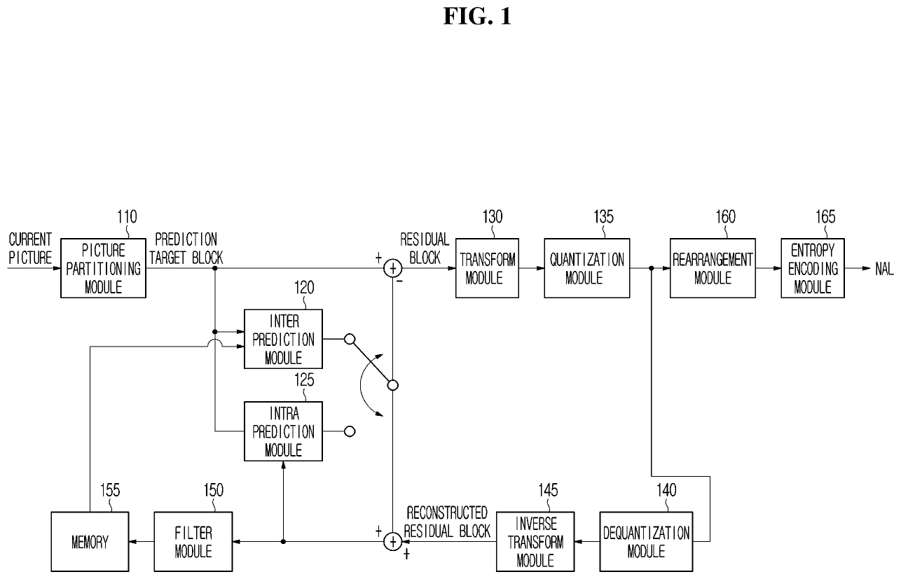

FIG. 1 is a block diagram showing an image encoding apparatus according to an embodiment of the present invention.

Referring to FIG. 1, an image encoding apparatus 100 may include a picture partitioning module 110, prediction modules 120 and 125, a transform module 130, a quantization module 135, a rearrangement module 160, an entropy encoding module 165, a dequantization module 140, an inverse transform module 145, a filter module 150, and a memory 155.

Constitutional parts shown in FIG. 1 are independently shown so as to represent characteristic functions different from each other. Thus, it does not mean that each constitutional part is constituted in a constitutional unit of separated hardware or software. In other words, each constitutional part includes each of enumerated constitutional parts for convenience. Thus, at least two constitutional parts of each constitutional part may be combined to form one constitutional part or one constitutional part may be divided into a plurality of constitutional parts to perform each function. The embodiment where each constitutional part is combined and the embodiment where one constitutional part is divided are also included in the scope of the present invention, if not departing from the essence of the present invention.

In addition, some of constituents may not be indispensable constituents performing essential functions of the present invention but be selective constituents improving only performance thereof. The present invention may be implemented by including only the indispensable constitutional parts for implementing the essence of the present invention except the constituents used in improving performance. The structure including only the indispensable constituents except the selective constituents used in improving only performance is also included in the scope of the present invention.

The picture partitioning module 110 may partition an input picture into at least one processing unit. Herein, the processing unit may be a prediction unit (PU), a transform unit (TU) or a coding unit (CU). The picture partitioning module 110 may partition one picture into a plurality of combinations of CUs, PUs and TUs and select one combination of CUs, PUs and TUs on the basis of a predetermined criterion (for example, a cost function), thereby encoding the picture.

For example, one picture may be partitioned into a plurality of CUs. A recursive tree structure, such as a quad tree structure, may be used to partition a picture into CUs. A CU partitioned into other CUs from a single image or a largest CU as root may be partitioned with as many child nodes as the partitioned CUs. A CU which is not partitioned any more in accordance with a predetermined limitation is a leaf node. That is, assuming that a CU may be partitioned into quadrants only, a single CU may be partitioned into at most four different CUs.

Hereinafter, in the embodiments of the present invention, a CU may be used to refer to not only a unit of encoding but also a unit of decoding.

A PU may be partitioned into at least one square or rectangular form with a same size in a CU. For PUs partitioned from one CU, any one PU may have a different shape and/or size from another PU.

When a PU for intra prediction is generated based on a CU and the CU is not a minimum CU, the CU may be subject to intra prediction without being partitioned into a plurality of PUs (N?).

The prediction modules 120 and 125 may include an inter prediction module 120 for performing inter prediction and an intra prediction module 125 for performing intra prediction. Whether to use inter prediction or intra prediction on a PU may be determined, and specific information (e.g. an intra prediction mode, a motion vector, and a reference picture) may be determined according to each prediction method. Herein, a processing unit on which prediction is performed may be different from a processing unit for which a prediction method and specific information thereon are determined. For example, a prediction method and a prediction mode may be determined for each PU, while prediction may be performed for each TU. A residual value (residual block) between a generated predicted block and an original block may be input to the transform module 130. In addition, prediction mode information, motion vector information and the like, which are used for prediction, may be encoded along with the residual value by the entropy encoding module 165 and be transmitted to a decoder. When a specific encoding mode is used, an original block itself may be encoded and transmitted to a decoding module without generating a prediction block through the prediction modules 120 and 125.

The inter prediction module 120 may predict a PU on the basis of information on at least one picture among a previous picture of a current picture and a subsequent picture of the current picture and may predict, depending on a situation, a PU on the basis of information on some regions within the current picture which are completely encoded. The inter prediction module 120 may include a reference picture interpolation module, a motion prediction module, and a motion compensation module.

The reference picture interpolation module may be provided with reference picture information from the memory 155 and generate pixel information less than an integer pixel from a reference picture. In the case of a luma pixel, a DCT-based 8-tap interpolation filter with a variable filter coefficient may be used to generate information on a pixel smaller than an integer pixel in a unit of a ¼ pixel. In the case of a chroma pixel, a DCT-based 4-tap interpolation filter with a variable filter coefficient may be used to generate information on a pixel smaller than an integer pixel in a unit of a ⅛ pixel.

The motion prediction module may perform motion prediction on the basis of a reference picture interpolated by the reference picture interpolation module. Various methods, such as a full search-based block matching algorithm (FBMA), a three-step search (TSS) algorithm and a new three-step search (NTS) algorithm, may be used to calculate a motion vector. A motion vector may have a motion vector value in the unit of a ½ or ¼ pixel on the basis of an interpolated pixel. The motion prediction module may predict a current PU using different motion prediction methods. Various methods, such as skip method, merge method, advanced motion vector prediction (AMVP) method, and intra block copy method may be used as motion prediction methods.

The intra prediction module 125 may generate a PU on the basis of information on a reference pixel around a current block, which is pixel information within a current picture. When a reference pixel is a pixel for which inter prediction is performed because a neighboring block of a current PU is a block for which inter prediction is performed, a reference pixel included in the block for which inter prediction is performed may be replaced with information on a reference pixel in the neighboring block for which intra prediction is performed. That is, when a reference pixel is not available, information on the unavailable reference pixel may be replaced with information on at least one reference pixel of the available reference pixels.

A prediction mode of intra prediction may have a directional prediction mode in which reference pixel information is used according to a prediction direction and a non-directional prediction mode in which information on a direction is not used in performing prediction. The number of the directional prediction modes may be equal to 33 as defined in the HEVC standard or be greater than 33, and for example, may be expanded to a number within a range of 60 to 70. A mode for predicting luma information and a mode for predicting chroma information may be different from each other, and intra prediction mode information used to obtain luma information or predicted luma signal information may be used to predict chroma information.

If a PU and a TU have a same size when intra prediction is performed, intra prediction on the PU may be performed based on a left pixel, an upper-left pixel and an upper pixel of the PU. On the other hand, if a PU and a TU have different sizes when intra prediction is performed, intra prediction may be performed using a reference pixel based on the TU. In addition, intra prediction using N? partitioning may be used only for a minimum CU.

An intra prediction method may generate a predicted block after an adaptive intra smoothing (AIS) filter is applied to a reference pixel according to a prediction mode. Different types of AIS filters may be applied to reference pixels. In order to perform an intra prediction method, an intra prediction mode of a current PU may be predicted from an intra prediction mode of a PU present around the current PU. When predicting a prediction mode of a current PU by using mode information predicted from a neighboring PU, if the current PU and the neighboring PU have a same intra prediction mode, information indicating that the current PU and the neighboring PU have the same prediction mode may be transmitted using predetermined flag information, and if the current PU and the neighboring PU have different prediction modes, information on the prediction mode of the current block may be encoded by performing entropy encoding.

In addition, a residual block may be generated including residual information which is a difference value between a PU, in which prediction is performed based on a PU generated in the prediction modules 120 and 125, and an original block of the PU. The generated residual block may be input to the transform module 130.

The transform module 130 may transform the residual block, which includes information on the residual between the original block and a PU generated through the prediction modules 120 and 125, by using a transform method such as Discrete Cosine Transform (DCT), Discrete Sine Transform (DST), and KLT. Whether to apply DCT, DST or KLT for transforming the residual block may be determined based on intra prediction mode information of the PU which is used to generate the residual block.

The quantization module 135 may quantize values transformed into a frequency domain by the transform module 130. A quantization coefficient may change depending on a block or importance of a picture. A value output from the quantization module 135 may be provided to the dequantization module 140 and the rearrangement module 160.

The rearrangement module 160 may rearrange coefficients with respect to quantized residual values.

The rearrangement module 160 may change a two-dimensional (2D) block form coefficient into a one-dimensional (1D) vector form through a coefficient scanning method. For example, the rearrangement module 125 may change a 2D block form coefficient into a 1D vector form by using a zig-zag scan method that scans DC coefficients up to coefficients of a high frequency domain. Instead of zig-zag scan, vertical scanning, which scans a 2D block form coefficient in a column direction, and horizontal scanning, which scans a 2D block form coefficient in a row direction, may be used according to a size of a TU and an intra prediction mode. That is, according to a size of a TU and an intra prediction mode, a scanning method for use may be determined among zigzag scanning, vertical scanning, and horizontal scanning.

The entropy encoding module 165 may perform entropy encoding on the basis of values obtained by the rearrangement module 160. Various encoding methods, such as exponential Golomb coding, context-adaptive variable length coding (CAVLC), or context-adaptive binary arithmetic coding (CABAC), may be used for entropy encoding.

The entropy encoding module 165 may encode a variety of information, such as residual coefficient information and block type information on a CU, prediction mode information, partitioning unit information, PU information, transfer unit information, motion vector information, reference frame information, block interpolation information and filtering information from the rearrangement module 160 and the prediction modules 120 and 125.

The entropy encoding module 165 may entropy-encode coefficients of a CU input from the rearrangement module 160.

The dequantization module 140 and the inverse transform module 145 dequantize values which are quantized by the quantization module 135 and inversely transform values which are transformed by the transform module 130. A residual value generated by the dequantization module 140 and the inverse transform module 145 may be added to a predicted PU, which is predicted through a motion estimation module, a motion compensation module, and intra prediction module in the prediction modules 120 and 125, and thus generate a reconstructed block.

The filter module 150 may include at least one of a deblocking filter, an offset correction module, and an adaptive loop filter (ALF).

The deblocking filter may remove block distortion generated by a boundary between blocks in a reconstructed picture. In order to determine whether or not to perform deblocking, whether or not to apply the deblocking filter to a current block may be determined based on pixels included in several columns or rows in the block. When the deblocking filter is applied to a block, a strong filter or a weak filter may be applied depending on a required deblocking filtering strength. In addition, when horizontal filtering and vertical filtering are performed in applying the deblocking filter, the horizontal filtering and the vertical filtering may be processed in parallel.

The offset correction module may correct an offset form an original image in the unit of a pixel on an image for which deblocking is performed. In performing offset correction for a specific picture, it is possible to use a method that distinguishes pixels in an image into a predetermined number of regions, determines a region for which offset is to be performed, and then applies an offset to the region, or a method that applies an offset by considering edge information of each pixel.

The adaptive loop filtering (ALF) may be performed based on a comparison value between a filtered reconstructed image and an original image. Pixels included in an image may be partitioned into predetermined groups, a filter to be applied to each group may be determined, and differential filtering may be performed for each group. Information on whether or not to apply the ALF may be transmitted by each coding unit (CU) in a luma signal, and the shape and coefficient of an ALF to be applied to each block may vary. In addition, an ALF with a same shape (fixed shape) may be applied irrespective of a feature of a block to which the ALF is to be applied.

The memory 155 may store a reconstructed block or picture produced through the filter module 150, and the stored reconstructed block or picture may be provided to the prediction modules 120 and 125 when performing inter prediction.

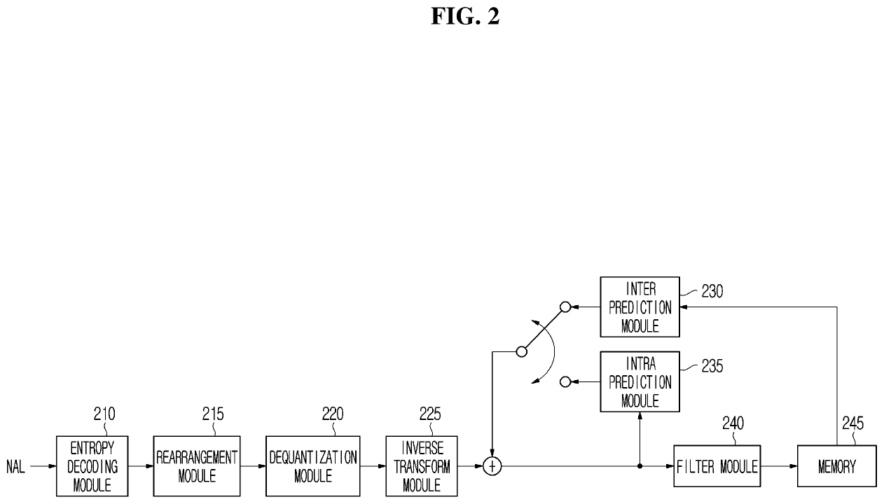

FIG. 2 is a block diagram showing an image decoding apparatus according to an embodiment of the present invention.

Referring to FIG. 2, an image decoder 200 may include an entropy decoding module 210, a rearrangement module 215, a dequantization module 220, an inverse transform module 225, prediction modules 230 and 235, a filter module 240, and a memory 245.

When an image bitstream is input from an image encoder, the input bitstream may be decoded according to an inverse process to the image encoder.

The entropy decoding module 210 may perform entropy decoding according to an inverse process to entropy encoding performed in an entropy encoding module of an image encoder. Various encoding methods, such as exponential Golomb coding, context-adaptive variable length coding (CAVLC), or context-adaptive binary arithmetic coding (CABAC), may be applied in response to a method performed in the image encoder.

The entropy decoding module 210 may decode information associated with intra prediction and inter prediction performed in an encoder.

The rearrangement module 215 may perform rearrangement on the bit stream entropy-decoded by the entropy decoding module 210 on the basis of the rearrangement method of the encoding module. The rearrangement module 215 may reconstruct and rearrange coefficients in a 1D vector form into coefficients in a 2D block. The rearrangement module 215 may be provided with information on coefficient scanning performed by the encoding module and may perform rearrangement through a method of inversely scanning on the basis of scanning order in which scanning is performed by the encoding apparatus.

The dequantization module 220 may perform dequantization on the basis of a quantization parameter provided from the encoder and the rearranged coefficients of the block.

The inverse transform module 225 may perform inverse transform, that is, inverse DCT, inverse DST, and inverse KLT, which are inverse to transform performed by the transform module, that is, DCT, DST, and KLT, on a result of quantization performed by the image encoder. Inverse transform may be performed based on a transfer unit determined by the video encoder. In the inverse transform module 225 of the image decoder, a transform method (e.g. DCT, DST, KLT) may be selectively performed according to multiple pieces of information such as a prediction method, a size of a current block, and a prediction direction.

The prediction modules 230 and 235 may generate a prediction block based on information associated with prediction block generation provided from the entropy decoding module 210 and information on a previously decoded block or picture provided from the memory 245.

When intra prediction is performed similarly to the operation in the image encoder as described above, if a PU and a TU have a same size, the intra prediction on the PU is performed based on a left pixel, an upper-left pixel and an upper pixel of the PU, and on the other hand, when intra prediction is performed, if a PU and a TU have different sizes, the intra prediction may be performed using a reference pixel based on the TU. In addition, intra prediction using N? partitioning may be used only for a minimum CU.

The prediction modules 230 and 235 may include a PU determination module, an inter prediction module, and an intra prediction module. The PU determination module may receive a variety of information, such as PU information, prediction mode information on an intra prediction method, and motion prediction-related information on an inter prediction method, which are input from the entropy decoding module 210, distinguish a PU in a current CU, and determine whether the PU performs inter prediction or intra prediction. An inter prediction module 230 may perform inter prediction on a current PU on the basis of information in at least one picture of a previous picture and a subsequent picture of a current picture including the current PU by using information necessary for inter prediction for the current PU provided from the image encoder. Alternatively, inter prediction may also be performed based on information on some regions that are already reconstructed in a current picture including a current PU.

In order to perform inter prediction, it may be determined, based on a CU, which of a skip mode, a merge mode, an AMVP mode, and an intra block copy mode is a motion prediction method for a PU included in the CU.

An intra prediction module 235 may generate a prediction block on the basis of pixel information in a current picture. When a PU is a PU for which intra prediction is performed, intra prediction may be performed based on intra prediction mode information on the PU provided from the image encoder. The intra prediction module 235 may include an AIS filter, a reference pixel interpolation module, and a DC filter. The AIS filter is a part that performs filtering on a reference pixel of a current block, and whether or not to apply the filter may be determined according to a prediction mode of a current PU and then the filter may be applied. AIS filtering may be performed on a reference pixel of a current block by using a prediction mode of a PU and AIS filter information provided from an image encoder. When a prediction mode of a current block is a mode that does not perform AIS filtering, the AIS filter may not be applied.

When a prediction mode of a PU is a prediction mode of performing intra prediction on the basis of pixel values obtained by interpolating reference pixels, the reference pixel interpolation module may generate reference pixels in a pixel unit less than an integer by interpolating the reference pixels. When a prediction mode of a current PU is a prediction mode of generating a prediction block without interpolating reference pixels, the reference pixels may not be interpolated. The DC filter may generate a prediction block through filtering, when a prediction mode of a current block is the DC mode.

A reconstructed block or picture may be provided to the filter module 240. The filter module 240 may include a deblocking filter, an offset correction module, and an ALF.

An image encoder may provide information on whether the deblocking filter is applied to a corresponding block or picture and information on which of a strong filter and a weak filter is applied when the deblocking filter is applied. The deblocking filter of the image decoder may be provided with information on the deblocking filter from an image encoder, and the image decoder may perform deblocking filtering on a corresponding block.

The offset correction module may perform offset correction on a reconstructed image based on a type of offset correction applied to an image in encoding and offset value information.

The ALF may be applied to a CU based on information regarding whether or not to apply the ALF and ALF coefficient information that are provided from an encoder. Such ALF information may be provided by being included in a specific parameter set.

The memory 245 may store a reconstructed picture or block to be used as a reference picture or a reference block and also provide the reconstructed picture to an output module.

As described above, in the embodiments of the present invention, the term “coding unit” is used for an encoding unit for a convenience of description, but it may also be a unit of decoding.

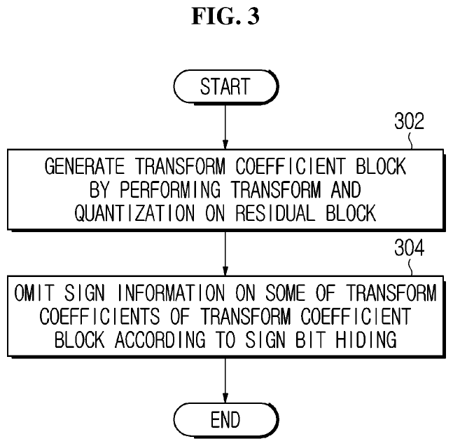

FIG. 3 shows an image encoding method that encodes a transform coefficient block, which is generated by transforming and quantizing a residual block, through sign bit hiding.

At step S302, transform and quantization are performed on a residual block, and thus a transform coefficient block is generated. The transform coefficient block may be generated by quantizing a residual block on which transform and quantization are performed.

At step S304, after the transform coefficient block is generated, encoding of sign information on some of transform coefficients of the transform coefficient block is omitted according to sign bit hiding.

Sign bit hiding may be performed in the transform coefficient block. Coefficients, to which sign bit hiding is applied in the transform coefficient block, may be restricted to any number N. The N is an integer equal to or greater than 2.

Signs of transform coefficients obtained from an encoding process may be transmitted through a sign bit hiding flag (1 bit). In addition, in a decoding process, whether or not sign bit hiding is applied may be determined through the sign bit hiding flag.

The sign bit hiding flag may be determined in a unit of transform coefficient block. Alternatively, the sign bit hiding flag may be determined in units of a coding block, a coding tree block, a slice, a tile, a picture, a coded video sequence (CVS), and a whole video, which are higher units than the transform coefficient block.

According to an embodiment, dequantization may be performed using a look-up table. In addition, as a sign bit hiding process is reflected in the look-up table, the sign bit hiding of step S304 may be merged with generation of a transform coefficient block according to the look-up table of step S302.

The look-up table may be determined among a plurality of look-up tables according to a quantization parameter used for generating a transform coefficient block. Alternatively, one look-up table may be selected from a plurality of look-up tables according to not only a quantization parameter but also other coding parameters.

When a look-up table is used, an amount of calculation required for generating a transform coefficient block may be reduced. However, a large memory capacity may be required to store a plurality of look-up tables.

According to an embodiment, at step S304, whether or not to hide a sign bit may be determined. At an encoding side, a reconstructed image, which is generated by decoding data that is encoded according to a specific encoding tool, is compared with an original image in order to verify a coding rate of the image according to the encoding tool. In addition, according to a comparison result, if there is a small difference between the reconstructed image and the original image, the encoding tool may be adopted. On the other hand, if there is a large difference between the reconstructed image and the original image, the encoding tool is not adopted.

Specifically, an optimal sign combination of transform coefficients may be determined by comparing a difference between a reconstructed image and an original image according to a sign combination of a plurality of transform coefficients. In addition, whether or not to perform sign bit hiding may be determined by comparing a difference between a reconstructed image and an original image when the sign bit hiding is performed according to an optimal sign combination of transform coefficients and a difference between the reconstructed image and the original image when the sign bit hiding is not performed.

A difference between a reconstructed image and an original image may be normalized into a sign bit cost. A sign bit cost may be determined according to similarity between reconstructed samples of a transform coefficient block according to a sign combination of transform coefficients and neighboring samples adjacent to the transform coefficient block.

A method of determining a sign bit cost may be determined differently according to a picture type. For example, a method of determining a sign bit cost when a picture type is I type (only intra prediction is allowed) and a method of determining a sign bit cost when a picture type is P type or B type (intra prediction and inter prediction are allowed) may be different from each other.

In addition, a method of determining a sign bit cost may be determined differently according to a transform method. For example, a method of determining a sign bit cost may be different according to whether a transform method applied to a transform coefficient block is a DCT transform or a DST transform. Alternatively, a method of determining a sign bit cost may be different according to whether or not a secondary transform is applied to a transform coefficient block. Alternatively, a method of determining a sign bit cost may be different according to a transform method applied to a vertical transform and a horizontal transform of a transform coefficient block. Alternatively, a method of determining a sign bit cost may be different according to a size of a transform coefficient block.

According to an embodiment, a sign bit cost for sign combinations of transform coefficients is determined according to the above-described method of determining a sign bit cost. In addition, sign combinations with a lowest sign bit cost are determined as an optimal sign combination. When an optimal sign combination corresponds to an actual sign combination of a transform coefficient block, it is determined that sign bit hiding is applied. In addition, when it is determined that sign bit hiding is applied, a sign bit hiding flag is determined as 1. On the other hand, when an optimal sign combination does not correspond to an actual sign combination of a transform coefficient block, it is determined that sign bit hiding is not applied. In addition, when it is determined that sign bit hiding is not applied, a sign bit hiding flag is determined as 0.

Alternatively, when a reconstructed block determined according to an optimal sign combination corresponds to a reconstructed block determined without sign bit hiding being applied, it is determined that the sign bit hiding is to be applied. In addition, when it is determined that sign bit hiding is applied, a sign bit hiding flag is determined as 1. On the other hand, when a reconstructed block determined according to an optimal sign combination does not correspond to a reconstructed block determined without sign bit hiding being applied, it is determined that the sign bit hiding is not to be applied. In addition, when it is determined that sign bit hiding is not applied, a sign bit hiding flag is determined as 0.

Hereinafter, a sign bit cost will be described in detail.

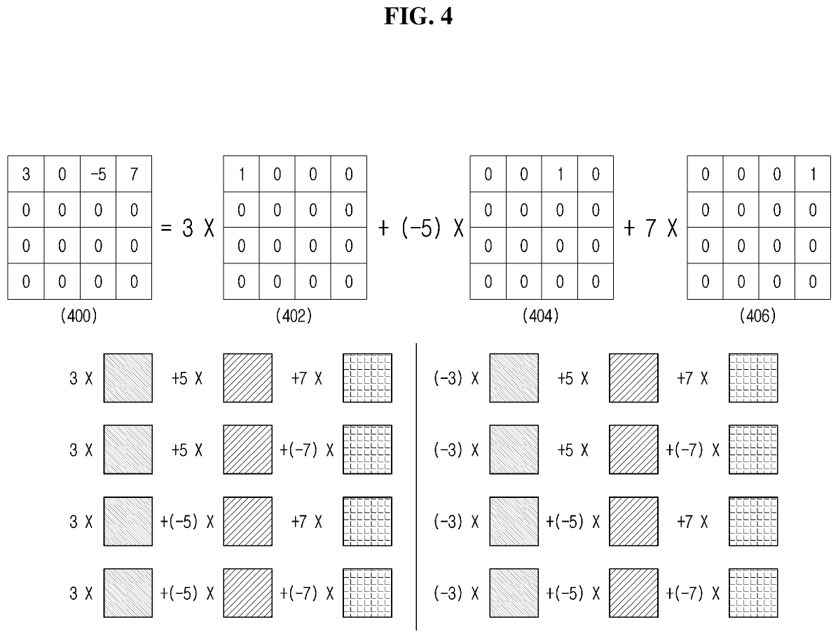

FIG. 4 shows one example of a transform coefficient block 400 and a sign combination of transform coefficients of the transform coefficient block.

The transform coefficient block 400 includes 3 non-zero transform coefficients and 13 zero transform coefficients. Accordingly, 3 sign bits are needed to represent signs of the 3 non-zero transform coefficients in the transform coefficient block 400. As for whether or not to apply sign bit hiding, a sign bit cost for a sing combination of the 3 non-zero transform coefficients of the transform coefficient block 400 may be determined. In addition, when an optimal sign combination with a lowest sign bit cost corresponds to a sign combination of the 3 non-zero transform coefficients of the transform coefficient block 400, sign bit hiding may be applied. On the other hand, when an optimal sign combination with a lowest sign bit cost corresponds to a sign combination of the 3 non-zero transform coefficients of the transform coefficient block 400, sign bit hiding may not be applied.

Because the transform coefficient block 400 includes the 3 non-zero transform coefficients, the transform coefficient block 400 has 2\hat{ }3 (=8) sign combinations according to signs. Specifically, sign combinations of (1,1,1) (1,1,1), (1,1,1), (1,1,1), (1,1,1), (1,1,1), (1,1,1), and (1,1,1) are present in the transform coefficient block 400. Accordingly, a sign bit cost according to each sign combination is calculated, and a sign combination with a lowest sign bit cost is determined as an optimal sign combination.

For fast calculation of a sign bit cost of each sign combination, a fast inverse transform of the transform coefficient block 400 is needed. For the fast inverse transform, the transform coefficient block 400 may be represented by a combination of a first block 402, a second block 404, and a third block 406, which include only one non-zero transform coefficient. In addition, according to an inverse transform result of the first block 402, the second block 404, and the third block 406, an inverse transform result of the transform coefficient block 400 may be quickly calculated.

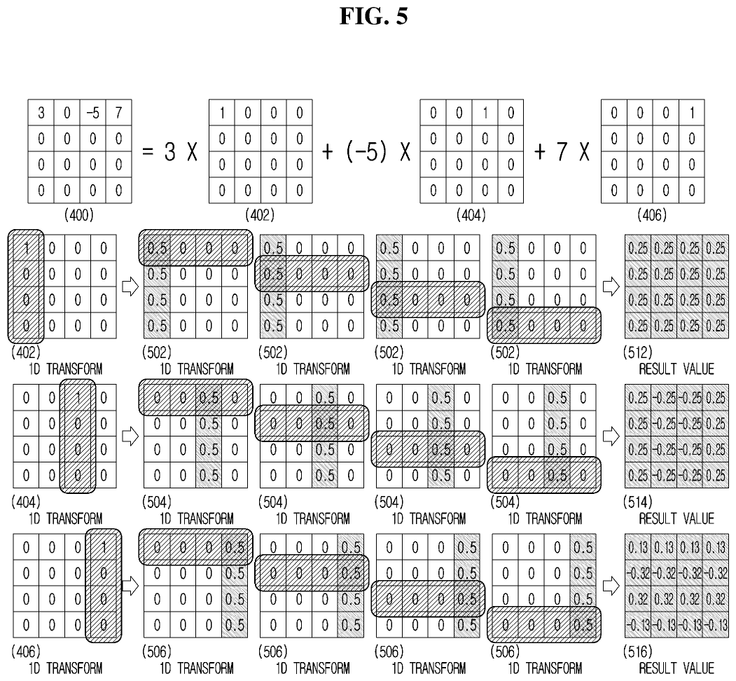

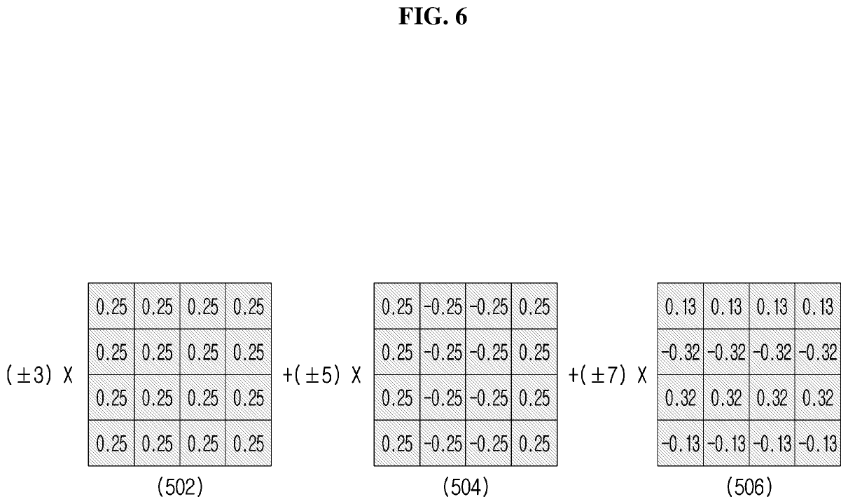

Hereinafter, a method of determining an optimal sign combination according to a floating-point DCT2 method will be described in FIG. 5 and FIG. 6.

FIG. 5 describes fast inverse transform according to a floating-point type DCT2 method.

According to FIG. 5, the transform coefficient block 400 is equal to a sum of 3 times the first block 402, (−5) times the second block 404, and 7 times the third block 406. For a fast inverse transform of the transform coefficient block, an inverse transform result value 512 of the first block 402, an inverse transform result value 514 of the second block 404, and an inverse transform result value 516 of the third block 406 may be set in advance.

The result value 512 may be generated by horizontally transforming an intermediate block 502 that is generated by vertically transforming the first block 402. The result value 514 may be generated by horizontally transforming an intermediate block 504 that is generated by vertically transforming the second block 404. The result value 516 may be generated by horizontally transforming an intermediate block 506 that is generated by vertically transforming the third block 406.

FIG. 6 describes a method of determining a residual block according to fast inverse transform according to a floating-point type DCT2 method.

In order to determine an optimal sign combination of non-zero transform coefficients of the transform coefficient block 400, a weighted sum of the result values 512, 514 and 516 of the first block 402, the second block 404, and the third block 406 may be used. For example, a residual block for a sign combination of (1,1,1) may be determined by adding 3 times the result value 512, 5 times the result value 514, and 7 times the result value 516. In addition, a residual block for the sign combination of (1,1,1) may be determined by adding (−3) times the result value 512, 5 times the result value 514, and 7 times the result value 516. For other combinations, a residual block may be determined by the same method.

As described in FIGS. 4 to 6, a total of eight residual blocks may be generated by a fast inverse transform according to a floating-point DCT2 method. Based on information a neighboring block adjacent to the transform coefficient block 400, a sign bit cost for the eight residual blocks may be determined. In addition, an optimal sign combination is determined based on a residual block with a lowest sign bit cost. When the optimal sign combination corresponds to an actual sign combination of non-zero transform coefficients of the transform coefficient block 400, it is determined that sign bit hiding is applied to the transform coefficient block 400. On the other hand, when the optimal sign combination does not correspond to an actual sign combination of non-zero transform coefficients of the transform coefficient block 400, it is determined that sign bit hiding is not applied to the transform coefficient block 400. When the sign bit hiding is not applied, signs of the transform coefficients of the transform coefficient block 400 are encoded.

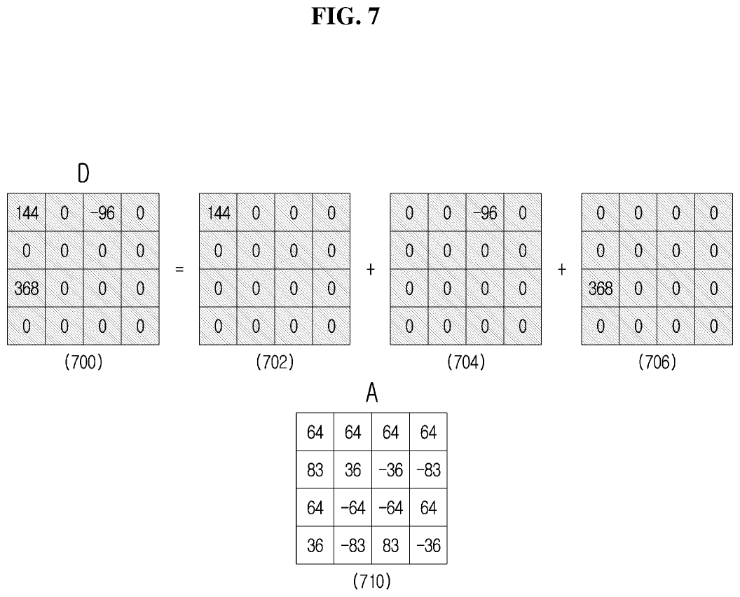

FIG. 7 describes one example of a transform coefficient block 700 and fast inverse transform according to an integer-type DCT2 method.

The transform coefficient block D 700 may be inverse transformed according to a 4×4 integer-type DCT-II matrix A 710. Specifically, an inverse transform result of the transform coefficient block D 700 may be determined by Equation 1 A^{T}DA.

For a fast inverse transform, the transform coefficient block D 700 may be represented by a combination of a first block 702, a second block 704, and a third block 706, which include only one non-zero transform coefficient. In addition, according to an inverse transform result of the first block 702, the second block 704, and the third block 706, an inverse transform result of the transform coefficient block 700 may be quickly calculated.

Because the transform coefficient block 400 includes the 3 non-zero transform coefficients, 2\hat{ }3 (=8) sign combinations are present. Accordingly, a sign bit cost according to each sign combination is calculated, and a sign combination with a lowest sign bit cost is determined as an optimal sign combination. According to a fast inverse transform based on an integer-type DCT2 method, a sign bit cost of each sign combination may be quickly calculated.

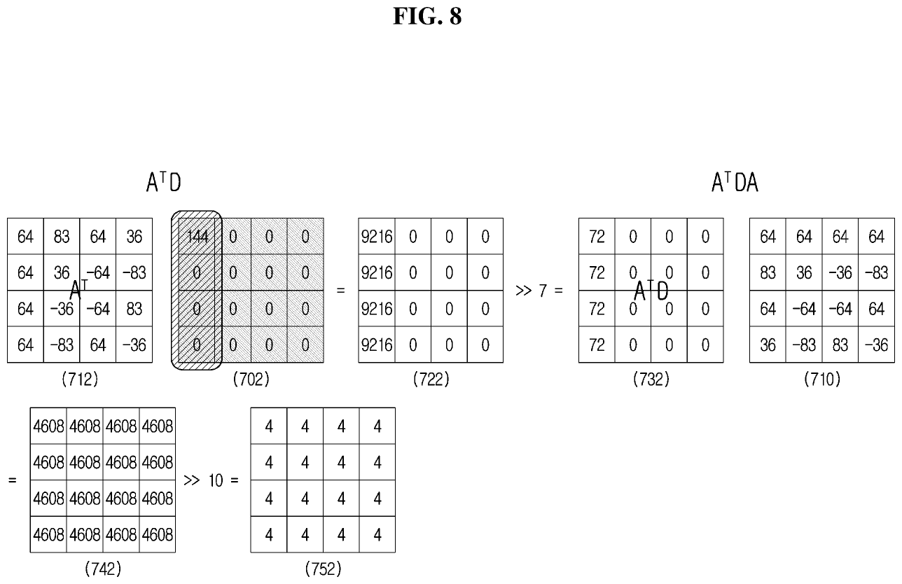

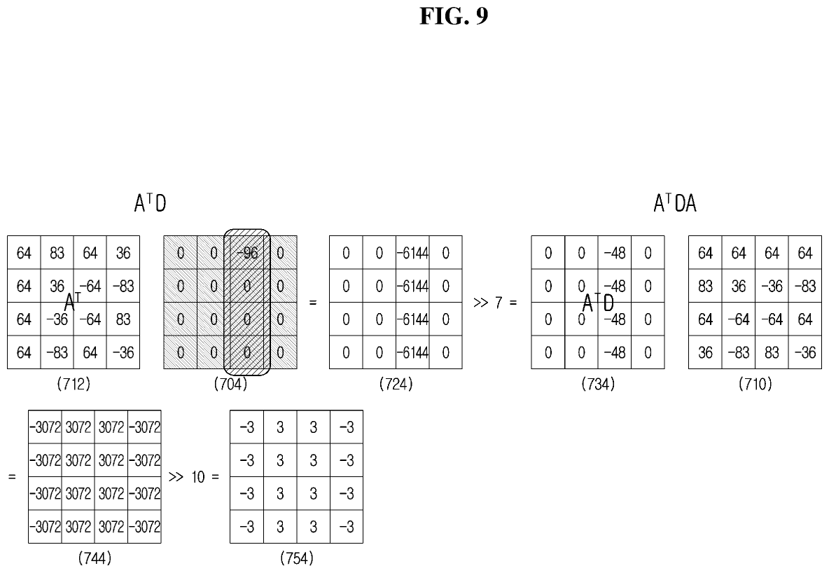

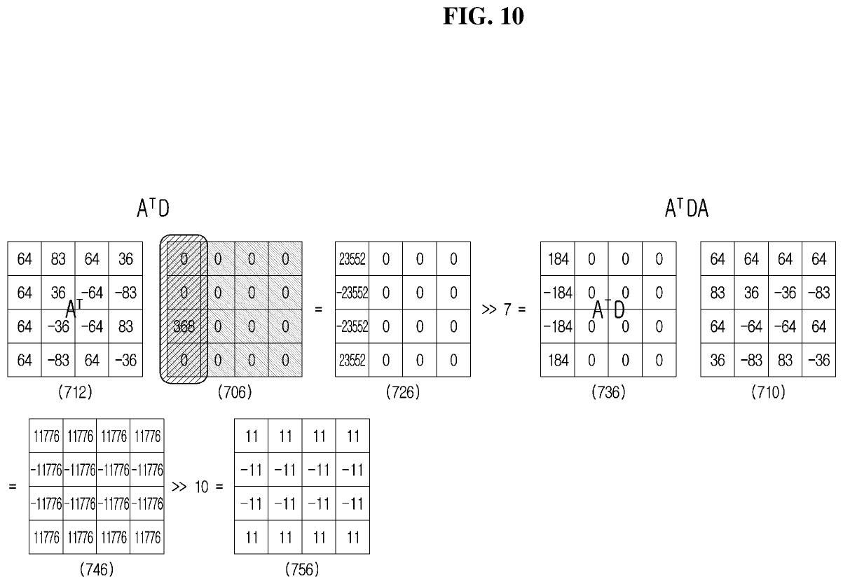

FIG. 8 to FIG. 10 describe a method for determining a first residual block 752, a second residual block 754, and a third residual block 756 of the first block 702, the second block 704, and the third block 706.

The first block 702 may be vertically inverse transformed by A^{T}712. According to the vertical inverse transform of the first block 702, a first vertical inverse transform block 722 is determined. A size of a transform coefficient of the first vertical inverse transform block 722 may be adjusted by a shift operation. Accordingly, according to a shift operation of the first vertical inverse transform block 722, a first intermediate block 732 may be generated. The first intermediate block 732 may be horizontally inverse transformed by A 710. According to the horizontal inverse transform of the first intermediate block 732, a first horizontal inverse transform block 742 is determined. Like the first vertical inverse transform block 722, a size of a transform coefficient of the first horizontal inverse transform block 724 may be adjusted by a shift operation. Accordingly, according to a shift operation of the first horizontal inverse transform block 742, a first residual block 752 may be generated.

Likewise, the second block 704 may be vertically inverse transformed by A^{T}712. According to the vertical inverse transform of the second block 704, a second vertical inverse transform block 724 is determined. A size of a transform coefficient of the second vertical inverse transform block 724 may be adjusted by a shift operation. Accordingly, according to a shift operation of the second vertical inverse transform block 724, a second intermediate block 734 may be generated. The second intermediate block 734 may be horizontally inverse transformed by A 710. According to the horizontal inverse transform of the second intermediate block 734, a second horizontal inverse transform block 744 is determined. Like the second vertical inverse transform block 724, a size of a transform coefficient of the second horizontal inverse transform block 744 may be adjusted by a shift operation. Accordingly, according to a shift operation of the second horizontal inverse transform block 744, a second residual block 754 may be generated.

Likewise, the third block 706 may be vertically inverse transformed by A^{T}712. According to the vertical inverse transform of the third block 706, a third vertical inverse transform block 726 is determined. A size of a transform coefficient of the third vertical inverse transform block 726 may be adjusted by a shift operation. Accordingly, according to a shift operation of the third vertical inverse transform block 726, a third intermediate block 736 may be generated. The third intermediate block 736 may be horizontally inverse transformed by A 710. According to the horizontal inverse transform of the third intermediate block 736, a third horizontal inverse transform block 746 is determined. Like the third vertical inverse transform block 726, a size of a transform coefficient of the third horizontal inverse transform block 746 may be adjusted by a shift operation. Accordingly, according to a shift operation of the third horizontal inverse transform block 746, a third residual block 756 may be generated.

The first residual block 752, the second residual block 754, and the third residual block 756 may be added according to 8 sign combinations. Specifically, sign combinations of (1,1,1) (1,1,1), (1,1,1), (1,1,1), (1,1,1), (1,1,1), (1,1,1), and (1,1,1) may be applied to an aggregating operation of the first residual block 752, the second residual block 754, and the third residual block 756. For example, according to a sign combination of (1,1,1), values of the first residual block 752, the second residual block 754, and the third residual block 756 are added up. In addition, a sign bit cost is calculated according to a residual block that is generated according to an added-up result. For the remaining sign combinations, a sign bit cost is calculated according to an added-up result of the first residual block 752, the second residual block 754, and the third residual block 756. Ultimately, depending on whether or not a sign combination with a lowest sign bit cost corresponds to an actual sign combination, whether or not to apply sign bit hiding is determined.

In FIG. 7 to FIG. 10, the first residual block 752, the second residual block 754, and the third residual block 756 are determined respectively for non-zero transform coefficients of 144, −96, and 368 of the transform coefficient block 700. That is, the sign combination of (1, 1, 1) is an actual sign combination of the transform coefficient block 700. Accordingly, according to an embodiment, whether or not to apply sign bit hiding may be determined according to whether or not a sign bit cost according to the sign combination of (1,1,1) is lower than sign bit costs according to the other sign combinations.

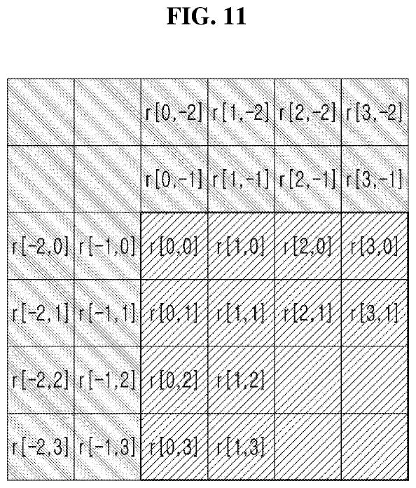

FIG. 11 shows one embodiment for determining a sign bit cost.

A residual block of a transform coefficient block, which is determined according to the above-described fast inverse transform method or any other inverse transform method, is added to a corresponding prediction block. By adding the residual block and the prediction block, a reconstructed block is generated. In addition, among samples of the reconstructed block corresponding to the transform coefficient block, a sign bit cost may be determined according to continuity between samples adjacent to a left boundary and/or an upper boundary and samples of a neighboring block of the reconstructed block.

One embodiment of a method for determining a sign bit cost is described in Equation 1 below.

$${cost}_{Sign - bit} = {\sum }_{x = 0}^{3} \vert ( - α ) \times r [ x , - 2 ] + ( - β ) \times r [ x , - 1 ] + β \times r [ x , 0 ] + α \times r [ x , 1 ] \vert + {\sum }_{y = 0}^{3} \vert ( - α ) \times r [ - 2 , y ] + ( - β ) \times r [ - 1 , y ] + β \times r [ 0 , y ] + α \times r [ 1 , y ] \vert \qquad [ Equation 1 ]$$

Based on Equation 1 above, a sign bit cost is calculated for each sign combination of a transform coefficient block. In addition, by comparing an optimal sign combination according to a sign bit cost and an actual sign combination of the transform coefficient block, whether or not to apply sign bit hiding to the transform coefficient block may be determined.

In Equation 1 above, α and β are any constants. For example, both α and β may be 1. Alternatively, α and β may be 1 and 2, respectively. α and β may be differently determined according to a prediction method of a current block. In Equation 1 above, r[x,y] means a sample value of the position (x,y) of a reconstructed block r. For example, r[1,1] means a sample value of the position (1,1) of the reconstructed block r.

In FIG. 11 and Equation 1 above, a sign bit cost is calculated based on samples spaced a distance of 2 samples from a boundary. However, according to an embodiment, a sign bit cost may also be calculated based on samples spaced a distance of one sample. Alternatively, according to an embodiment, a sign bit cost may also be calculated based on samples spaced a distance of N samples. The N is equal to or greater than 3.

In FIG. 4 to FIG. 10, a method of hiding sign bits of three transform coefficients is described. However, according to an embodiment, whether or not to hide sign bits of two transform coefficients may be determined. Alternatively, according to an embodiment, whether or not to hide sign bits of four or more transform coefficients may be determined.

In the above embodiment, whether or not to apply sign bit hiding to a transform coefficient block is determined according to whether or not an optimal sign combination is identical with an actual sign combination. However, according to an embodiment, even when an optimal sign combination and an actual sign combination are different from each other, if a reconstruction error is small between the optimal sign combination and the actual sign combination, sign bit hiding may be applied.

According to an embodiment, a method of calculating a sign bit cost may be differently determined according to features of a transform coefficient block and a current picture. For example, depending on a prediction mode corresponding to a transform coefficient block, a method of calculating a sign bit cost may be determined. Alternatively, by considering a prediction mode of a transform coefficient block and a prediction mode of a neighboring block, a method of calculating a sign bit cost may be determined. Alternatively, according to a picture type of a current picture, a method of calculating a sign bit cost may be determined. Specifically, according to whether a current picture is an I picture allowing only intra prediction or a P picture or a B picture allowing inter prediction, a method of calculating a sign bit cost may be determined. Alternatively, according to a transform method applied to a transform coefficient block, a method of calculating a sign bit cost may be determined. Alternatively, according to a quantization parameter applied to a transform coefficient block, a method of calculating a sign bit cost may be determined. Alternatively, according to a type of an in-loop filter applied to a transform coefficient block, a method of calculating a sign bit cost may be determined.

A position of a transform coefficient, to which sign bit hiding is applied, may be determined in various methods. For example, for consecutive non-zero transform coefficients that are first scanned in a scan order, sign bit hiding may be applied. Alternatively, for consecutive non-zero transform coefficients that are later scanned in a scan order, sign bit hiding may be applied.

Alternatively, for non-zero transform coefficients that are located far from an upper-left side of a transform coefficient block, sign bit hiding may be applied. On the other hand, for non-zero transform coefficients that are located close to the upper-left side of the transform coefficient block, sign bit hiding may be applied.

Alternatively, among transform coefficients of a transform coefficient block, for transform coefficients that are smaller than a predetermined size, sign bit hiding may be applied. On the other hand, among transform coefficients of a transform coefficient block, for transform coefficients that are greater than a predetermined size, sign bit hiding may be applied.

Alternatively, among consecutive transform coefficients that are first scanned in a scan order, for transform coefficients that are smaller than a predetermined size, sign bit hiding may be applied. On the other hand, among consecutive transform coefficients that are later scanned in a scan order, for transform coefficients that are smaller than a predetermined size, sign bit hiding may be applied.

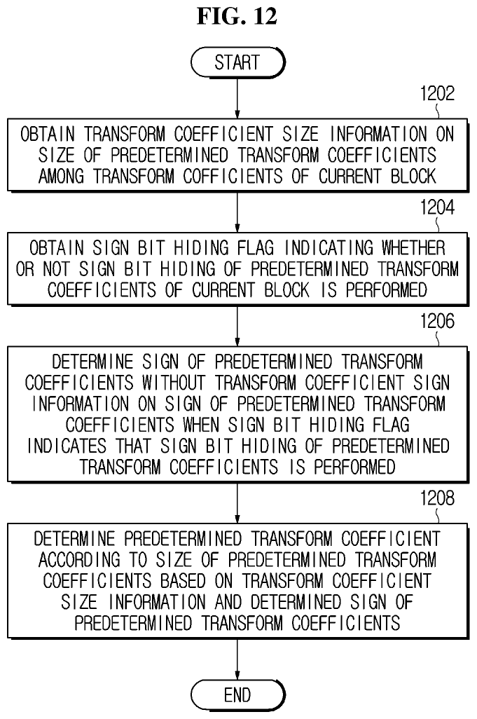

FIG. 12 describes a video decoding method using sign bit hiding.

At step S1202, transform coefficient size information is obtained for sizes of predetermined transform coefficients among transform coefficients of a current block.

In an embodiment, the predetermined transform coefficients may be determined by at least one of a scan order of the current block, a threshold value of the transform coefficient size, and a position of the transform coefficients. The number of the predetermined transform coefficients may be equal to or greater than 3.

At step S1204, a sign bit hiding flag is obtained which indicates whether or not sign bit hiding is performed for the predetermined transform coefficients of the current block.

According to an embodiment, a sign bit hiding enable flag may be obtained which indicates whether or not sign bit biding is allowed for one of a coding tree block of the current block, a slice, a tile, a picture, a sequence, and a video. In addition, a sign bit hiding flag may be obtained when the sign bit hiding enable flag indicates that the sign bit hiding is allowed.

At step S1206, when the sign bit hiding flag indicates that sign bit hiding of the predetermined transform coefficients is performed, signs of the predetermined transform coefficients are determined without obtaining transform coefficient sign information on signs of the predetermined transform coefficients.

According to an embodiment, when the sign bit hiding flag indicates that sign bit hiding of the predetermined transform coefficients is not performed, transform coefficient sign information on signs of the predetermined transform coefficients are obtained. In addition, the signs of the predetermined transform coefficients are determined according to the transform coefficient sign information.

According to an embodiment, a sign bit cost may be determined for each sign combination for the predetermined transform coefficients. In addition, an optimal sign combination may be determined according to the sign bit cost. In addition, the signs of the predetermined transform coefficients may be determined according to the optimal sign combination.

According to an embodiment, in order to determine a sign bit cost, a residual block of a current block according to a sign combination is determined. In addition, a reconstructed block of the current block is determined from the residual block. A sign bit cost of a sign combination is determined based on the reconstructed block and a neighboring block of the current block.

According to an embodiment, according to a fast inverse transform, a residual block of the current block according to the sign combination may be determined.

According to an embodiment, in order to determine the sign bit cost of the sign combination, according to similarity between samples of a reconstructed block adjacent to a left boundary of the current block and samples of a left neighboring block of the current block and similarity between samples of a reconstructed block adjacent to an upper boundary of the current block and samples of an upper neighboring block of the current block, the sign bit cost of the sign combination may be determined.

According to an embodiment, the sign bit cost of the sign combination may be determined according to at least one of a size of the current block, a prediction mode, a transform mode, and a quantization parameter.

According to an embodiment, a sign combination with a least sign bit cost is determined as an optimal sign combination.

At step S1208, the predetermined transform coefficients are determined according to sizes of the predetermined transform coefficients according to the transform coefficient size information and the determined signs of the predetermined transform coefficients.

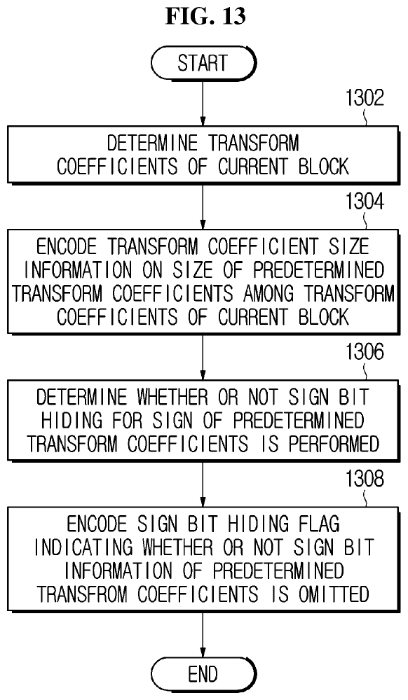

FIG. 13 describes a video encoding method using sign bit hiding.

At step S1302, transform coefficients of a current block are determined.

At step S1304, transform coefficient size information is obtained for sizes of predetermined transform coefficients among the transform coefficients of the current block.

In an embodiment, the predetermined transform coefficients may be determined by at least one of a scan order of the current block, a threshold value of the transform coefficient size, and a position of the transform coefficients. The number of the predetermined transform coefficients may be equal to or greater than 3.

At step S1306, whether or not sign bit hiding is performed for signs of the predetermined transform coefficients is determined.

According to an embodiment, a sign bit cost may be determined for each sign combination applicable to the predetermined transform coefficients. According to the sign bit cost, an optimal sign combination may be determined among sign combinations applicable to the predetermined transform coefficients. Whether or not the sign bit hiding of the predetermined transform coefficients is performed may be determined according to the optimal sign combination.

According to an embodiment, a residual block of the current block according to a sign combination is determined. A reconstructed block of the current block is determined from the residual block. A sign bit cost of a sign combination is determined based on the reconstructed block and a neighboring block of the current block.

According to an embodiment, according to a fast inverse transform, a residual block of the current block according to the sign combination may be determined.

According to an embodiment, according to similarity between samples of a reconstructed block adjacent to a left boundary of the current block and samples of a left neighboring block of the current block and similarity between samples of a reconstructed block adjacent to an upper boundary of the current block and samples of an upper neighboring block of the current block, the sign bit cost of the sign combination may be determined.

According to an embodiment, the sign bit cost of the sign combination may be determined according to at least one of a size of the current block, a prediction mode, a transform mode, and a quantization parameter.

According to an embodiment, whether or not the sign bit hiding of the predetermined transform coefficients is performed may be determined according to whether or not the optimal sign combination among the sign combinations applicable to the predetermined transform coefficients corresponds to a sign combination applied to the predetermined transform coefficients.

At step S1308, a sign bit hiding flag is obtained which indicates whether or not sign bit information of the predetermined transform coefficients is omitted.

According to an embodiment, a sign bit hiding enable flag may be encoded which indicates whether or not sign bit biding is allowed for one of a coding tree block of the current block, a slice, a tile, a picture, a sequence, and a video. In addition, step S1306 and step S1308 may be performed when the sign bit hiding enable flag indicates that sign bit hiding is allowed.

According to an embodiment, a bitstream, which is encoded video data according to the video encoding method, is generated. In addition, the generated bitstream may be transmitted to a video decoder or be stored in a computer-readable recording medium. In addition, the bitstream transmitted to the video decoder may be decoded according to the video decoding method.

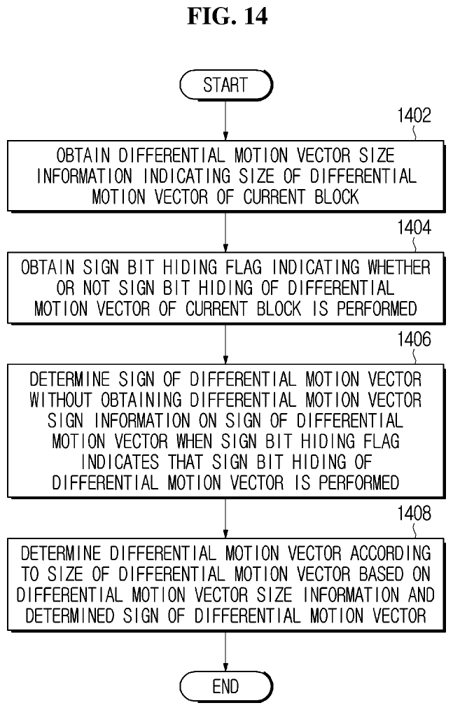

FIG. 14 shows an image encoding method that encodes a differential motion vector through sign bit hiding.

At step S1402, after inter prediction of a current block is performed, a differential motion vector of the current block is determined.

At step S1404, differential motion vector size information on a size of a differential motion vector of the current block is encoded. The differential motion vector size information may indicate an absolute value of an x component of the differential motion vector and an absolute value of a y component.

At step S1406, whether or not sign bit hiding is performed for a sign of the differential motion vector is determined. A sign bit cost may be determined for each sign combination applicable to the differential motion vector. In addition, according to the sign bit cost, an optimal sign combination is determined among sign combinations applicable to the differential motion vector. According to the determined optimal sign combination, whether or not the sign bit hiding of the differential motion vector is determined.

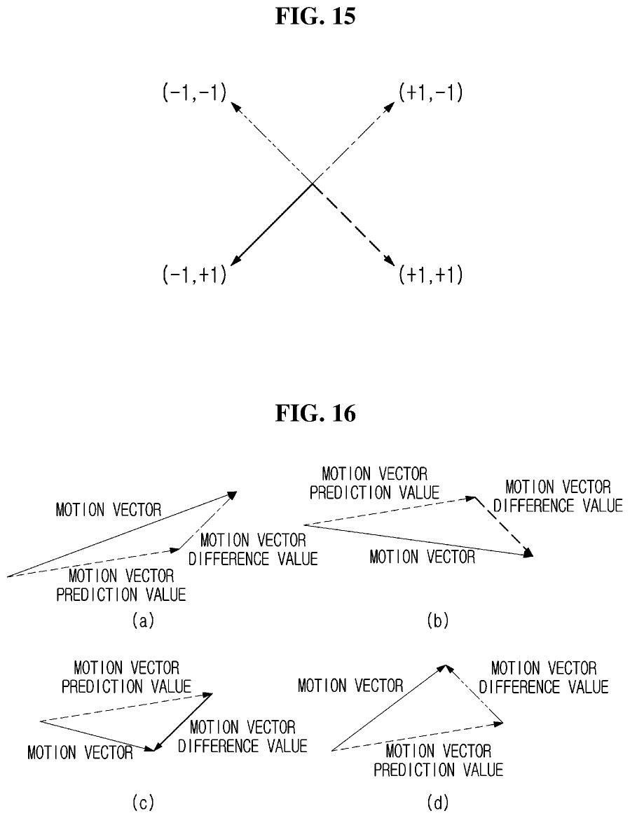

The sign combinations include (+,+), (+,−), (−,+), and (−,−). Specifically, each of the sign combinations is applied to an absolute value of an x component and an absolute value of a y component of a differential motion vector. Accordingly, a sign bit cost is determined for each of the sign combinations. In FIG. 15 and FIG. 16, contents about a sign combination of a differential motion vector are described.

In FIG. 15, four cases of differential motion vectors according to sign combinations are illustrated when an absolute value of the differential motion vectors is (1, 1). According to FIG. 15, when a sign combination is (+,+), a differential motion vector is determined as (1,1). In addition, when sign combinations are (+,−), (−,+) and (−,−), differential motion vectors are determined as (1,−1), (−1,1), and (−1,−1) respectively.

In FIG. 16, one embodiment of a differential motion vector according to four sign combinations is illustrated. (a) of FIG. 16 shows a differential motion vector when a sign combination is (+,−). (b) of FIG. 16 shows a differential motion vector when a sign combination is (+,+). (c) of FIG. 16 shows a differential motion vector when a sign combination is (−,+). (d) of FIG. 16 shows a differential motion vector when a sign combination is (−,−). As an example, in FIG. 16, a sign bit cost is calculated based on a differential motion vector of each sign combination.

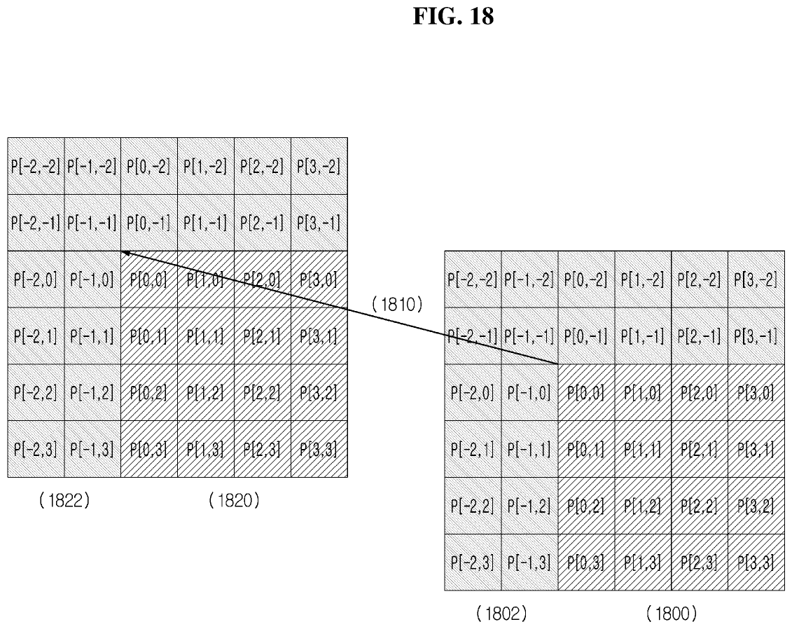

For example, a first sign bit cost is determined when a first sign combination (+,+) is applied to an absolute value of an x component and an absolute value of a y component of a differential motion vector determined at step S1402. Likewise, when a second sign combination (+,−), a third sign combination (−,+), and a fourth sign combination (−,−) are applied to the absolute value of the x component and the absolute value of the y component of the differential motion vector, a second sign bit cost, a third sign bit cost, and a fourth sign bit cost are determined. A sign bit cost may be determined according to a method of determining a sign bit cost in FIG. 18. According to another example, a sign bit cost may be determined according to a method of determining a sign bit cost, which is similar to FIG. 11.

As described above, four differential motion vector candidates are determined by the sign combinations. In addition, four final motion vector candidates are determined by the four differential motion vector candidates. Sign bit costs are determined for the four final motion vector candidates.

Specifically, according to a final motion vector candidate based on a sign combination, a reference block of the current block is determined. In addition, a sign bit cost of the sign combination is determined from a plurality of neighboring pixels of the current block and a plurality of neighboring pixels of the reference block. Positions of the plurality of neighboring pixels of the current block and positions of the plurality of neighboring pixels of the reference block correspond to each other.

A neighboring pixel range including the plurality of neighboring pixels of the current block, which is necessary to calculate a sign bit cost, may be determined. A range of the plurality of neighboring pixels of the current block may include neighboring pixels in a predetermined position around the current block, and the plurality of neighboring pixels of the current block may be a predetermined number of neighboring pixels.

At step S1408, sign bit hiding information, which indicates whether or not sign bit information of a differential motion vector is omitted, is encoded. The sign bit hiding information may be a one-bit flag.

According to an embodiment, when both the x component and y component of the differential motion vector determined at step S1402 are 0, whether or not to apply sign bit hiding is not determined.

In addition, when one of the x component and the y component of the differential motion vector is 0, whether or not to apply sign bit hiding may not be determined. For example, when the x component is 0 and the y component is not 0, since only a one-bit sign bit flag for the y component is encoded, there is no bit reduction that may be expected by encoding sign bit hiding information. That is, only when neither the x component nor the y component of the differential motion vector is 0, whether or not to apply sign bit hiding may be determined.

According to an embodiment, sign bit hiding information may be encoded in a coding block unit. Alternatively, according to an embodiment, sign bit hiding information may be encoded, and the sign bit hiding information may be set to be applied to every block included in a block with a predetermined size. In addition, according to an embodiment, sign bit hiding information may be encoded in units of a coding tree block, a slice, a picture, a sequence, or a video, and the sign bit hiding information may be set to be applied to every block included in the units of the coding tree block, the slice, the picture, the sequence, or the video.

The sign bit hiding information may be entropy encoded. Entropy encoding of the sign bit hiding information may be based on exponential Golomb coding or context-adaptive binary arithmetic coding (CABAC). When the sign bit hiding information is entropy encoded based on CABAC, a context needed for CABAC may be determined according to an absolute value of a differential motion vector.

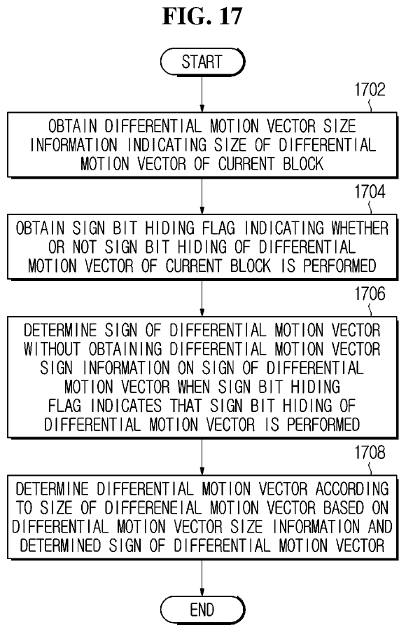

FIG. 17 shows an image decoding method that decodes a differential motion vector through sign bit hiding.

At step S1702, differential motion vector size information indicating a size of a differential motion vector of a current block may be obtained. In addition, from the differential motion vector size information, absolute values of an x component and a y component of the differential motion vector are determined.

At step S1704, sign bit hiding information, which indicates whether or not sign bit hiding is performed for the differential motion vector of the current block, is obtained. The sign bit hiding information may be a flag with a size of one bit.

At step S1706, when a sign bit hiding flag indicates that the sign bit hiding of the differential motion vector is performed, a sign of the differential motion vector may be determined without obtaining differential motion vector sign information on the sign of the differential motion vector.

When the sign bit hiding information indicates that the differential motion vector is encoded through the sign bit hiding, a sign bit cost of each sign combination is determined.

An optimal sign combination is determined according to the determined sign bit cost. In addition, according to the optimal sign combination, signs of the x component and y component of the differential motion vector are determined. For example, a sign combination with a least sign bit cost may be determined as the optimal sign combination. A sign combination with a least sign bit cost among a first sign bit cost to a fourth sign bit cost may be determined as an optimal sign combination. In addition, according to the optimal sign combination, a sign of a differential motion vector may be determined.

In order to determine a sign bit cost of a sign combination, a reference block of a current block may be determined according to a sign combination of a differential motion vector. In addition, the sign bit cost of the sign combination may be determined from a plurality of neighboring pixels of the current block and a plurality of neighboring pixels of the reference block. Positions of the plurality of neighboring pixels of the current block and positions of the plurality of neighboring pixels of the reference block correspond to each other.

In order to determine the sign bit cost of the sign combination, an absolute value of a difference value between the neighboring pixels of the current block and the neighboring pixels of the reference block may be determined. In addition, the sign bit cost of the sign combination may be determined from the absolute value of the difference value.

In order to determine the sign bit cost of the sign combination, a range of the plurality of neighboring pixels of the current block, which are referenced to calculating a sign bit cost, may be determined. A range of the plurality of neighboring pixels of the reference block corresponds to the range of the plurality of neighboring pixels of the current block. The range of the plurality of neighboring pixels of the current block may include neighboring pixels in a predetermined position around the current block, and the plurality of neighboring pixels of the current block may include a predetermined number. The range of the plurality of neighboring pixels of the reference block corresponds to the range of the plurality of neighboring pixels of the current block.

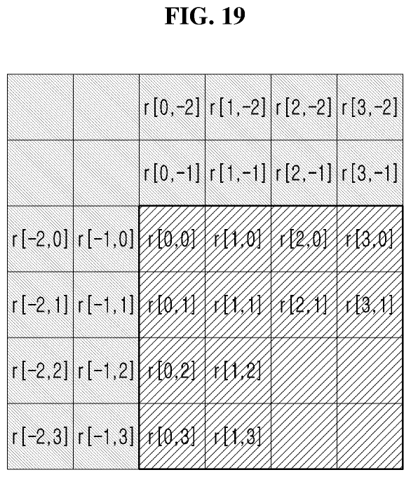

A specific method of determining a sign bit cost will be described in detail in FIG. 18 and FIG. 19.

On the other hand, when the sign bit hiding information indicates that the differential motion vector is not encoded through the sign bit hiding, sign information of the differential motion vector is decoded. In addition, a sign of the differential motion vector is determined based on the sign information.

At step S1708, the differential motion vector is determined according to a size of the differential motion vector based on differential motion vector size information and the determined sign of the differential motion vector. In addition, a motion vector is determined using the differential motion vector and a prediction motion vector.

According to an embodiment, when both the x component and y component of the differential motion vector determined at step S1702 are 0, sign bit hiding information is not decoded.

In addition, when one of the x component and the y component of the differential motion vector is 0, sign bit hiding information may not be decoded. Instead, a one-bit sign bit flag may be decoded for a non-zero component of the x component and the y component. That is, only when neither the x component nor the y component of the differential motion vector is 0, sign bit hiding information may be decoded.

According to an embodiment, sign bit hiding information may be decoded in a coding block unit. Alternatively, according to an embodiment, sign bit hiding information may be decoded, and the sign bit hiding information may be applied to every block included in a block with a predetermined size. In addition, according to an embodiment, sign bit hiding information may be decoded in units of a coding tree block, a slice, a picture, a sequence, or a video, and the sign bit hiding information may be applied to every block included in the units of the coding tree block, the slice, the picture, the sequence, or the video.

The sign bit hiding information may be entropy decoded. Entropy decoding of the sign bit hiding information may be based on exponential Golomb coding or CABAC. When the sign bit hiding information is entropy decoded based on CABAC, a context needed for CABAC may be determined according to an absolute value of a differential motion vector.

In the above description, a method of determining whether or not to apply sign bit hiding of a differential motion vector is described by assuming that uni-prediction is applied to a current block. However, when bi-prediction is applied to a current block, whether or not to apply sign bit hiding may be determined, in encoding, for each of a differential motion vector for a list 0 and a differential motion vector for a list 1.

According to an embodiment, during an encoding process, whether or not to apply sign bit hiding may be determined for a list 0 differential motion vector (or a first differential motion vector) for the list 0. An optimal sign combination with a least sign bit cost for the list 0 differential motion vector is determined, and it is determined whether or not the optimal sign combination corresponds to a sign combination of the list 0 differential motion vector. In addition, according to a result of the determination, for the list 0 differential motion vector, the first sign bit hiding information for the list 0 may be encoded.

Likewise, during the encoding process, whether or not to apply sign bit hiding may be determined for a list 1 differential motion vector (or a second differential motion vector) for the list 1. An optimal sign combination with a least sign bit cost for the list 1 differential motion vector is determined, and it is determined whether or not the optimal sign combination corresponds to a sign combination of the list 1 differential motion vector. In addition, according to a result of the determination, for the list 1 differential motion vector, the second sign bit hiding information for the list 1 may be encoded.

According to an embodiment, during a decoding process, when only the first sign bit hiding information is 1, an optimal sign combination is determined according to sign bit cost measurement only for the list 0 differential motion vector. In addition, according to the optimal sign combination, the list 0 differential motion vector is determined.

According to an embodiment, during the decoding process, when only the second sign bit hiding information is 1, an optimal sign combination is determined according to sign bit cost measurement only for the list 1 differential motion vector. In addition, according to the optimal sign combination, the list 1 differential motion vector is determined.

According to an embodiment, during the decoding process, when both the first sign bit hiding information and the second sign bit hiding information are 1, optimal sign combinations may be determined independently of each other for the list 0 differential motion vector and the list 1 differential motion vector. In addition, the list 0 differential motion vector may be determined according to an optimal sign combination of the list 0 differential motion vector, and the list 1 differential motion vector may be determined according to an optimal sign combination of the list 1 differential motion vector.

According to an embodiment, a single piece of sign bit hiding information, which indicates whether or not sign bit hiding is applied for the list 0 differential motion vector and the list 1 differential motion vector, may be determined. Accordingly, by encoding only one piece of sign bit hiding information, the coding rate may be improved better than when encoding both first sign bit hiding information and second sign bit hiding information.

In case only one piece of sign bit hiding information, which indicates whether or not sign bit hiding is applied to the list 0 and the list 1, is encoded, sign bit costs for 16 sign combinations are calculated by being determined by combinations of a sign of an x component and a sign of a y component of the list 0 differential motion vector and a sign of an x component and a sign of a y component of the list 1 differential motion vector. In addition, a sign combination with a least sign bit cost among 16 sign combinations is determined as an optimal sign combination. According to the optimal sign combination, the signs of the x component and y component of the list 0 differential motion vector and the signs of the x component and y component of the list 1 differential motion vector are determined. In addition, a single piece of sign bit hiding information, which indicates whether or not sign bit hiding is applied for the list 0 differential motion vector and the list 1 differential motion vector, is encoded.

In case only one piece of sign bit hiding information is decoded, when the sign bit hiding information indicates that sign bit hiding is applied to the list 0 and the list 1, sign bit costs for 16 sign combinations are calculated by being determined by combinations of a sign of an x component and a sign of a y component of the list 0 differential motion vector and a sign of an x component and a sign of a y component of the list 1 differential motion vector. In addition, according to the optimal sign combination, the signs of the x component and y component of the list 0 differential motion vector and the signs of the x component and y component of the list 1 differential motion vector are determined. In addition, according to the determined signs, the list 0 differential motion vector and the list 1 differential motion vector are determined.

According to an embodiment, the list 1 differential motion vector may be determined from the list 0 differential motion vector, or the list 0 differential motion vector may be determined from the list 1 differential motion vector. For example, the list 1 differential motion vector may be determined based on at least one of the list 0 differential motion vector, a list 0 prediction motion vector, and a distance between a current picture and a reference picture. Accordingly, only first sign bit hiding information for the list 0 may be encoded, and encoding of second sign bit hiding information for the list 1 may be omitted. On the other hand, only the second sign bit hiding information for the list 1 may be encoded, and encoding of the first sign bit hiding information for the list 0 may be omitted.

As a specific example of the embodiment, absolute values of an x component and a y component of the list 1 differential motion vector may be determined to be identical with those of an x component and a y component of the list 1 differential motion vector, and the signs of the x component and y component of the list 1 differential motion vector may be opposite to the signs of the x component and y component of the list 0 differential motion vector. Accordingly, encoding of the second sign bit hiding information for the list 1 may be omitted, and the list 1 differential motion vector may be determined from the list 0 differential motion vector.

In a decoding process, a single sign bit hiding flag, which indicates whether or not sign bit hiding of the list 0 differential motion vector of the current block, may be obtained. In addition, when the sign bit hiding flag indicates that the sign bit hiding of the list 0 differential motion vector is performed, the sign of the list 0 differential motion vector may be determined without obtaining the list 0 differential motion vector sign information for the sign of the list 0 differential motion vector, and the list 0 differential motion vector may be determined according to the sign of the list 0 differential motion vector based on the list 0 differential motion vector size information and the determined sign of the list 0 differential motion vector. In addition, the list 1 differential motion vector of the current block may be determined based on the determined list 0 differential motion vector.

On the other hand, when the sign bit hiding flag indicates that sign bit hiding of the list 1 differential motion vector is performed, the list 1 differential motion vector is first derived, and the list 0 differential motion vector is determined based on the determined list 1 differential motion vector.

According to an embodiment, sign bit hiding enable information, which indicates whether or not sign bit hiding is allowed for a differential motion vector, may be encoded for at least one unit of a slice, a picture, a sequence, and a video. In addition, in an encoding process, when the sign bit hiding enable information indicates that sign bit hiding is allowed for a differential motion vector, sign bit hiding information may be encoded. In addition, in a decoding process, when the sign bit hiding enable information indicates that sign bit hiding is allowed for a differential motion vector, sign bit hiding information may be decoded.

On the other hand, in an encoding process, when the sign bit hiding enable information indicates that sign bit hiding is not allowed for a differential motion vector, sign bit hiding information is not encoded. Likewise, in a decoding process, when the sign bit hiding enable information indicates that sign bit hiding is not allowed for a differential motion vector, sign bit hiding information is not decoded.

FIG. 18 illustrate one embodiment for a method of determining a sign bit cost for sign bit hiding of a differential motion vector.

As described above, in order to determine an optimal sign combination of a differential motion vector, a sign bit cost is determined. A sign bit cost of a differential motion vector is determined by comparing a neighboring pixel 1802 of a current block 1800 and a neighboring pixel 1822 of a reference block 1820 that is represented by a motion vector 1810 according to the differential motion vector.

According to an embodiment, ranges of the compared neighboring pixels 1802 and 1822 may be differently set. For example, only neighboring pixels immediately adjacent to the current block 1800 and the reference block 1820 may be used to determine a sign bit cost. That is, P(−1,0), P(−1,1), P(−1,2), P(−1,3), P(0,−1), P(1,−1), P(2,−1), and P(3,−1), which are immediately adjacent to the current block 1800, and P′(−1,0), P′(−1,1), P′(−1,2), P′(−1,3), P′(0,−1), P′(1,−1), P′(2,−1), and P′(3,−1), which are immediately adjacent to the reference block 1820, may be used to determine a sign bit cost.

As another example, neighboring pixels, which are spaced two pixel units from the current block 1800 and the reference block 1820, may be used to determine a sign bit cost. Accordingly, P(−2,0), P(−2,1), P(−2,2), P(−2,3), P(0,−2), P(1,−2), P(2,−2), and P(3,−2), which are spaced two pixel units from the current block 1800, and P′(−2,0), P′(−2,1), P′(−2,2), P′(−2,3), P′(0,−2), P′(1,−2), P′(2,−2), and P′(3,−2), which are spaced two pixel units from the reference block 1820, may be additionally used to determine a sign bit cost.

As another example, upper-left neighboring pixels of the current block 1800 and the reference block 1820 may be used to determine a sign bit cost. Accordingly, P(−1,−1) immediately adjacent to the current block 1800 and P′(−1,−1) immediately adjacent to the reference block 1820 may be additionally used to determine a sign bit cost. Alternatively, P(−2,−1), P(−1,−2), and P(−2,−2), which are spaced two pixel units from the current block 1800, and P′(−1,−1), P′(−2,−1), P′(−1,−2), and P′(−2,−2), which are spaced two pixel units from the reference block 1820, may be additionally used to determine a sign bit cost.

According to an embodiment, neighboring pixels, which are spaced three or more pixel units from the current block 1800 and the reference block 1820, may be additionally used to determine a sign bit cost.

According to an embodiment, for fast sign bit cost calculation, only a predetermined number of neighboring pixels in a specific position may be used to calculate a sign bit cost. For example, only four neighboring pixels in a specific position may be used to calculate a sign bit cost. For example, P(−1,0), P(−1,2), P(0,−1), and P(2,−1) around the current block 1800 and P′(−1,0), P′(−1,2), P′(0,−1), and P′(2,−1) around the reference block 1820 may be used to calculate a sign bit cost. Alternatively, P(−1,1), P(−1,3), P(1,−1), and P(3,−1) around the current block 1800 and P′(−1,1), P′(−1,3), P′(1,−1), and P′(3,−1) around the reference block 1820 may be used to calculate a sign bit cost. The embodiment is merely an example, and the specific position may be selected from samples illustrated in FIG. 18 according to an embodiment.

According to an embodiment, according to a size of the current block 1800, the number of neighboring pixels necessary to calculate a sign bit cost may be determined. The number of necessary neighboring pixels may be proportional to a size of the current block 1800. For example, when four neighboring pixels for a 4×4 size block are used for a sign bit cost, 8 neighboring pixels for a 8×8 size block may be set to be used for a sign bit cost.

According to an embodiment, regardless of the size of the current block 1800, the number of neighboring pixels necessary to calculate a sign bit cost may be fixed. The number of necessary neighboring pixels may be 4. Alternatively, according to an embodiment, the number of necessary neighboring pixels may be determined as 8, 16, 32 or more.

According to an embodiment, according to a shape of the current block 1800, positions of neighboring pixels necessary to calculate a sign bit cost may be determined. For example, when the current block 1800 has a width longer than a height, as for neighboring pixels used for a sign bit cost, more neighboring pixels adjacent to the top of the current block may be used than neighboring pixels adjacent to the left side of the current block. On the other hand, when the current block 1800 has a height longer than a width, as for neighboring pixels used for a sign bit cost, more neighboring pixels adjacent to the left side of the current block may be used than neighboring pixels adjacent to the top of the current block.

When a range of neighboring pixels for determining a sign bit cost is determined as above, the sign bit cost is determined based on neighboring pixels in the range. Herein, the sign bit cost may be determined as a sum of absolute difference (SAD) between neighboring pixels of the current block 1800 and neighboring pixels of the reference block 1820. Equation 2 below shows a method of calculating a sign bit cost when using only neighboring pixels immediately adjacent to a current block and a reference block, which have a size of M×N, for determining the sign bit cost.

$${cost}_{Sign - bit} = {\sum }_{x = 0}^{M - 1} \vert P [ x , - 1 ] - {P}^{′} [ x , - 1 ] \vert + {\sum }_{y = 0}^{N - 1} \vert P [ - 1 , y ] - {P}^{′} [ - 1 , y ] \vert \qquad [ Equation 2 ]$$

In FIG. 18, for convenience of explanation, a range of neighboring pixels for determining a sign bit cost is described based on a block of 4×4 size. However, the above-mentioned embodiments are applicable to blocks with various sizes.

The method of calculating a sign bit cost according to FIG. 18 may be applied, when sign bit hiding of a differential motion vector of a current block is performed without encoding or decoding sign bit hiding information for the current block. On the other hand, the method of calculating a sign bit cost according to FIG. 18 may be applied, when sign bit hiding information for the current block is encoded or decoded and sign bit hiding of a differential motion vector of the current block is performed.

FIG. 19 shows one embodiment for determining a sign bit cost.

According to an embodiment, a sign bit cost may be determined from a reconstructed block that is determined by a sign bit combination.

In order to determine a sign bit cost, a differential motion vector for a sign bit combination may be determined. In addition, a motion vector may be determined from the differential motion vector. In addition, a prediction block of a current block may be determined from the motion vector. In addition, a reconstructed block of the current block may be determined from the prediction block of the current block.

As described in FIG. 11, a sign bit cost may be determined according to continuity of samples between a reconstructed block of a current block and a neighboring block of the current block. Specifically, a sign bit cost may be determined according to continuity between samples adjacent to a left boundary and/or an upper boundary and samples of a neighboring block of the reconstructed block. The samples of the neighboring block may be a left neighboring block, an upper neighboring block, and an upper left neighboring block.

According to an embodiment, a sign bit cost may be determined according to continuity of samples between a prediction block of a current block, instead of a reconstructed block of the current block, and a neighboring block of the current block.

According to an embodiment, a sign bit cost may be determined as in Equation 1, which is described in FIG. 11.

Based on Equation 1, a sign bit cost may be calculated for each sign combination of a current block. In addition, by comparing an optimal sign combination according to the sign bit cost and an actual sign combination of the current block, whether or not to apply sign bit hiding to a differential motion vector of the current block may be determined.

In Equation 1 above, a sign bit cost is calculated based on samples spaced a distance of 2 samples from a boundary. However, according to an embodiment, a sign bit cost may also be calculated based on samples spaced a distance of one sample. Alternatively, according to an embodiment, a sign bit cost may also be calculated based on samples spaced a distance of N samples. The N is equal to or greater than 3.

In Equation 1, every sample adjacent to an upper boundary is described to be used to calculate a sign bit cost. However, to reduce complexity of calculating a sign bit cost, only some samples adjacent to an upper boundary may be set for use. For example, among samples adjacent to an upper boundary, only samples with a predetermined value of an x coordinate may be used to calculate a sign bit cost.

For example, when a block has a size of N×M and N is greater than M, a sign bit cost may be calculated by using samples adjacent to an upper boundary. On the other hand, when N is smaller than M, a sign bit cost may be calculated by using samples adjacent to a left boundary.

As another example, when inter prediction is performed both for an upper block and for a left block, a sign bit cost may be calculated by using samples adjacent to an upper boundary and samples adjacent to a left boundary.

As another example, when inter prediction is performed for an upper block and intra prediction is performed for a left block, a sign bit cost may be calculated by using samples adjacent to an upper boundary. On the other hand, when inter prediction is performed for a left block and intra prediction is performed for an upper block, a sign bit cost may be calculated by using samples adjacent to a left boundary.

In Equation 1, every sample adjacent to a left boundary is described to be used to calculate a sign bit cost. However, to reduce complexity of calculating a sign bit cost, only some samples adjacent to a left boundary may be set for use. For example, among samples adjacent to a left boundary, only samples with a predetermined value of a y coordinate may be used to calculate a sign bit cost.

In FIG. 19, a method of determining a sign bit cost is described for a block with a size of 4×4. However, this is merely an example, and the method of determining a sign bit cost in FIG. 19 may be applied to a block with a different size.

The method of calculating a sign bit cost according to FIG. 19 may be applied, when sign bit hiding information for the current block is encoded or decoded and sign bit hiding of a differential motion vector of the current block is performed. On the other hand, the method of calculating a sign bit cost according to FIG. 19 may be applied, when sign bit hiding of a differential motion vector of a current block is performed without encoding or decoding sign bit hiding information for the current block.

The method of determining a differential motion vector described in FIG. 14 to FIG. 19 may be applied to a variety of inter prediction coding tools. For example, it may be applied to AMVP mode, merge mode, affine mode, and subblock-based merge mode.

In the above-described embodiments, the methods are described based on the flowcharts with a series of steps or units, but the present invention is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or one or more steps may be deleted from the flowcharts without influencing the scope of the present invention.

The embodiments include various aspects of examples. All possible combinations for various aspects may not be described, but those skilled in the art will be able to recognize different combinations. Accordingly, the present invention may include all replacements, modifications, and changes within the scope of the claims.

The embodiments of the present invention may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present invention, or well-known to a person of ordinary skilled in computer software technology field. Examples of the computer-readable recording medium include magnetic recording media such as hard disks, floppy disks, and magnetic tapes, optical data storage media such as CD-ROMs or DVD, magneto-optimum media such as floptical disks; and hardware devices, such as read-only memory (ROM), random-access memory (RAM), flash memory, etc., which are particularly structured to store and implement the program instruction. Examples of the program instructions include not only a mechanical language code formatted by a compiler but also a high level language code that may be implemented by a computer using an interpreter. The hardware devices may be configured to be operated by one or more software modules or vice versa to conduct the processes according to the present invention.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

1. A video decoding method, comprising:
obtaining transform coefficient size information on a size of predetermined transform coefficients among transform coefficients of a current block;
obtaining a sign bit hiding flag indicating whether or not sign bit hiding of the predetermined transform coefficients of the current block is performed;
determining a sign of the predetermined transform coefficients without obtaining transform coefficient sign information on the sign of the predetermined transform coefficients, when the sign bit hiding flag indicates that the sign bit hiding of the predetermined transform coefficients is performed; and
determining the predetermined transform coefficients according to the size of the predetermined transform coefficients based on the transform coefficient size information and the determined sign of the predetermined transform coefficients.

2. The method of claim 1, wherein the determining of the sign of the predetermined transform coefficients comprises:
determining a sign bit cost for each of sign combinations for the predetermined transform coefficients;
determining an optimal sign combination according to the sign bit cost; and
determining the sign of the predetermined transform coefficients according to the optimal sign combination.

3. The method of claim 2, wherein the determining of the sign bit cost for each of the sign combinations for the predetermined transform coefficients comprises:
determining a residual block of the current block according to a sign combination;
determining a reconstructed block of the current block from the residual block; and
determining a sign bit cost of the sign combination based on the reconstructed block and a neighboring block of the current block.

4. The method of claim 3, wherein the determining of the residual block of the current block according to the sign combination determines, according to fast inverse transform, the residual block of the current block according to the sign combination.

5. The method of claim 3, wherein the determining of the sign bit cost of the sign combination based on the reconstructed block and the neighboring block of the current block determines the sign bit cost of the sign combination according to similarity between samples of the reconstructed block adjacent to a left boundary of the current block and samples of a left neighboring block of the current block and similarity between samples of the reconstructed block adjacent to an upper boundary of the current block and samples of an upper neighboring block of the current block.

6. A video encoding method, comprising:
determining transform coefficients of a current block;
encoding transform coefficient size information on a size of predetermined transform coefficients among the transform coefficients of the current block;
determining whether or not sign bit hiding for a sign of the predetermined transform coefficients is performed; and
encoding a sign bit hiding flag indicating whether or not sign bit information of the predetermined transform coefficients is omitted.

7. The method of claim 6, wherein the determining of whether or not sign bit hiding for the sign of the predetermined transform coefficients is performed comprises:
determining a sign bit cost for each of sign combinations applicable to the predetermined transform coefficients;
determining an optimal sign combination among the sign combinations applicable to the predetermined transform coefficients according to the sign bit cost; and
determining, according to the optimal sign combination, whether or not sign bit hiding of the predetermined transform coefficients is performed.

8. The method of claim 7, wherein the determining of the sign bit cost for each of the sign combinations for the predetermined transform coefficients comprises:
determining a residual block of the current block according to a sign combination;
determining a reconstructed block of the current block from the residual block; and
determining a sign bit cost of the sign combination based on the reconstructed block and a neighboring block of the current block.

9. The method of claim 8, wherein the determining of the residual block of the current block according to the sign combination determines, according to fast inverse transform, the residual block of the current block according to the sign combination.

10. The method of claim 8, wherein the determining of the sign bit cost of the sign combination based on the reconstructed block and the neighboring block of the current block determines the sign bit cost of the sign combination according to similarity between samples of the reconstructed block adjacent to a left boundary of the current block and samples of a left neighboring block of the current block and similarity between samples of the reconstructed block adjacent to an upper boundary of the current block and samples of an upper neighboring block of the current block.

11. A video decoding method, comprising:
obtaining differential motion vector size information indicating a size of a differential motion vector of a current block;
obtaining a sign bit hiding flag indicating whether or not sign bit hiding of the differential motion vector of the current block is performed;
determining a sign of the differential motion vector without obtaining differential motion vector sign information on the sign of the differential motion vector, when the sign bit hiding flag indicates that the sign bit hiding of the differential motion vector is performed; and
determining the differential motion vector according to the size of the differential motion vector based on the differential motion vector size information and the determined sign of the differential motion vector.

12. The method of claim 11, wherein the determining of the sign of the differential motion vector comprises:
determining a sign bit cost for each of sign combinations for the differential motion vector;
determining an optimal sign combination according to the sign bit cost; and
determining the sign of the differential motion vector according to the optimal sign combination, and
wherein a sign combination with a least sign bit cost is determined as an optimal sign combination.

13. The method of claim 12, wherein the determining of the sign bit cost for each of the sign combinations for the differential motion vector comprises:
determining a reference block of the current block according to a sign combination; and
determining a sign bit cost of the sign combination from a plurality of neighboring pixels of the current block and a plurality of neighboring pixels of the reference block, and
wherein a position of the plurality of neighboring pixels of the current block and a position of the plurality of neighboring pixels of the reference block correspond to each other.

14. The method of claim 13, wherein the determining of the sign bit cost of the sign combination from the neighboring pixels of the current block and the neighboring pixels of the reference block comprises:
determining an absolute value of a differential value between the neighboring pixels of the current block and the neighboring pixels of the reference block; and
determining the sign bit cost of the sign combination from the absolute value of the differential value.

15. The method of claim 13, wherein the determining of the sign bit cost of the sign combination from the plurality of neighboring pixels of the current block and the plurality of neighboring pixels of the reference block comprises determining a range of the plurality of neighboring pixels of the current block, and
wherein a range of the plurality of neighboring pixels of the reference block corresponds to the range of the plurality of neighboring pixels of the current block.

16-20. (canceled)
